(19) United States
(12) Patent Application Publication
(10) Pub. No.: US 2026/0228566 A1
(43) Pub. Date: Aug. 6, 2026

(54) IDENTIFYING COMPONENTS AND PATTERNS IN DIGITAL DESIGNS

(71) Applicant: U.S. BANK NATIONAL ASSOCIATION, Minneapolis, MN (US)

(72) Inventors: Giacomo Domeniconi, Long Island City, NY (US); Samuel Assefa, Washington, DC (US)

(21) Appl. No.: 19/044,971

(22) Filed: Feb. 4, 2025

(51) Int. Cl. G06N 5/022

(52) U.S. Cl. CPC G06N 5/022

(57) ABSTRACT

Various embodiments are directed to apparatuses, methods, computer-readable media, computer program products, and systems related to generating predicted classifications from interface design data objects. In some embodiments, the method may comprise receiving an interface design data object, the interface design data object comprising a text-based representation of a graphical user interface; generating, an input data object based on the interface design data object, the input data object representing a plurality of nodes related to each other based on the interface design data object indicating at least one parent or child node; applying the input data object to a graph neural network configured to generate at least one predicted classification associated with at least one of the plurality of nodes; and based on the at least one predicted classification, generating an update to the graphical user interface.

### FIELD

The present disclosure relates to systems, methods, computer readable media, assemblies, components, and apparatuses for generating predicted classifications from interface design data objects and updating graphical user interfaces.

### BACKGROUND

Existing technology cannot effectively detect similarities between components of graphical user interfaces, determine the compliance of components based on compliance parameters, or facilitate automatic reusability of preapproved components due to current technological deficiencies, particularly across different software programs and with custom made components. Applicant has identified a number of additional challenges associated with identifying components, preapproved components, and determining compliance of a graphical user interface and/or its parts with given parameters. Through applied effort, ingenuity, and innovation many deficiencies of existing systems have been solved by developing solutions that are in accordance with the embodiments as discussed herein, many examples of which are described in detail herein.

### BRIEF SUMMARY

In general, embodiments of the present disclosure provided herein may relate to generating an update to a graphical user interface. Other implementations for generating an update to a graphical user interface will be, or will become, apparent to one with skill in the art upon examination of the following figures and detailed description. It is intended that all such additional implementations be included within this description be within the scope of the disclosure and be protected by the following claims.

In some embodiments, a component prediction system comprises at least one processor and at least one memory, the at least one memory comprising computer coded instructions therein, wherein the computer coded instructions are configured to, when executed by the at least one processor, cause the component prediction system to: receive an interface design data object, the interface design data object comprising a text-based representation a graphical user interface; generate an input data object based on the interface design data object, the input data object representing the plurality of nodes related to each other based on the interface design data object indicating the at least one parent or child node; apply the input data object to a graph neural network configured to generate at least one predicted classification associated with at least one of the plurality of nodes; and based on the at least one predicted classification, generate an update to the graphical user interface.

In some embodiments, the input data object comprises (i) a node feature matrix comprising one or more vectorized representations of the plurality of nodes comprising features associated with the plurality of nodes, and (ii) an adjacency matrix comprising one or more vectorized representations of the plurality of nodes related to each other. In some embodiments, a component of the graphical user interface comprises one or more of the plurality of nodes, the one or more of the plurality of nodes comprising at least one root node defining a start of the component. In some embodiments, the computer coded instructions are configured to, when executed by the at least one processor, further cause the system to: query an application programming interface (API) using a file key or uniform resource locator (URL) associated with the interface design data object to receive the interface design data object.

In some embodiments, the computer coded instructions are configured to, when executed by the at least one processor, further cause the component prediction system to: train the graph neural network using training data comprising a text-based representation of each of a plurality of labeled nodes of at least one graphical user interface, wherein a labeled node of the plurality of labeled nodes comprises at least a label indicating a component classification of the labeled node. In some embodiments, the computer coded instructions are configured to, when executed by the at least one processor, further cause the component prediction system to: train the graph neural network using training data comprising a text-based representation of each of a plurality of nodes, wherein the plurality of nodes comprise a preapproved component associated with a component classification. In some embodiments, generating the at least one predicted classification comprises generating, via the graph neural network, at least one node-level classification for at least one of the plurality of nodes indicating at least one of (i) a component classification, or (ii) a root classification, and wherein the at least one predicted classification comprises the at least one node-level classification.

In some embodiments, generating the at least one predicted classification comprises generating, via the graph neural network, at least one graph-level classification for at least two of the plurality of nodes indicating a component classification, and wherein the at least one predicted classification comprises the at least one graph-level classification. In some embodiments, the computer coded instructions are configured to, when executed by the at least one processor, further cause the component prediction system to: apply a root node voting system to determine a root classification for at least one node of a graph respective to the at least one graph-level classification. In some embodiments, generating an update to the graphical user interface comprises at least one of (i) providing an indication of at least one component within the graphical user interface to be reviewed, (ii) providing an indication of at least one component within the graphical user interface to be replaced with at least one preapproved component, or (iii) replacing at least one component within the graphical user interface with at least one preapproved component.

Some embodiments are directed to a computer-implemented method comprising: causing, by one or more processors, receiving an interface design data object, the interface design data object comprising a text-based representation of each of a graphical user interface; generating an input data object based on the interface design data object, the input data object representing a plurality of nodes related to each other based on the interface design data object indicating at least one parent or child node; applying the input data object to a graph neural network configured to generate at least one predicted classification associated with at least one of the plurality of nodes; and based on the at least one predicted classification, generating an update to the graphical user interface.

In some embodiments, the input data object comprises (i) a node feature matrix comprising one or more vectorized representations of the plurality of nodes comprising features associated with the plurality of nodes, and (ii) an adjacency matrix comprising one or more vectorized representations of the plurality of nodes related to each other. In some embodiments, a component of the graphical user interface comprises one or more of the plurality of nodes, the one or more of the plurality of nodes comprising at least one root node defining a start of the component. In some embodiments, the computer-implemented method further comprises querying an application programming interface (API) using a file key or uniform resource locator (URL) associated with the interface design data object to receive the interface design data object.

In some embodiments, the computer-implemented method further comprises training the graph neural network using training data comprising a text-based representation of each of a plurality of labeled nodes of at least one graphical user interface, wherein a labeled node of the plurality of labeled nodes comprises at least a label indicating a component classification of the labeled node. In some embodiments, the computer-implemented method further comprises training the graph neural network using training data comprising a text-based representation of each of a plurality of nodes, wherein the plurality of nodes comprise a preapproved component associated with a component classification. In some embodiments, generating the at least one predicted classification comprises generating, via the graph neural network, at least one node-level classification for at least one of the plurality of nodes indicating at least one of (i) a component classification, or (ii) a root classification, and wherein the at least one predicted classification comprises the at least one node-level classification.

In some embodiments, generating the at least one predicted classification comprises generating, via the graph neural network, at least one graph-level classification for at least two of the plurality of nodes indicating a component classification, and wherein the at least one predicted classification comprises the at least one graph-level classification. In some embodiments, the computer-implemented method further comprises applying a root node voting system to determine a root classification for at least one node of a graph respective to the at least one graph-level classification. In some embodiments, generating an update to the graphical user interface comprises at least one of (i) providing an indication of at least one component within the graphical user interface to be reviewed, (ii) providing an indication of at least one component within the graphical user interface to be replaced with at least one preapproved component, or (iii) replacing at least one component within the graphical user interface with at least one preapproved component.

### BRIEF DESCRIPTION OF THE DRAWINGS

Reference will now be made to the accompanying drawings, which are not necessarily drawn to scale, and wherein:

FIG. 1 illustrates an example system environment within which at least some embodiments of the present disclosure may operate.

FIG. 2 illustrates a block diagram of an apparatus that may be specifically configured in accordance with various embodiments of the present disclosure and within which at least some embodiments of the present disclosure may operate.

FIG. 3 illustrates an example data flow diagram showing example data structures in accordance with at least some embodiments of the present disclosure.

FIG. 4 illustrates an example data flow diagram showing example data structures in accordance with at least some embodiments of the present disclosure.

FIG. 5 illustrates an example data flow diagram showing example data structures in accordance with at least some embodiments of the present disclosure.

FIG. 6 illustrates an example graphical user interface presented in accordance with one or more embodiments of the present disclosure.

FIG. 7A illustrates an example representation of the structure associated with a graphical user interface in accordance with at least some embodiments of the present disclosure.

FIG. 7B illustrates an example of a labeling technique that may be applied in accordance with one or more embodiments of the present disclosure.

FIG. 8 illustrates an example of a tree structure presented in accordance with one or more embodiments of the present disclosure.

FIG. 9 illustrates an example interface design data object in accordance with at least some example embodiments of the present disclosure.

FIG. 10 illustrates an example flowchart depicting operations in accordance with at least some example embodiments of the present disclosure.

FIG. 11 illustrates an example machine learning framework for use with embodiments of the present disclosure.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. While values for dimensions of various elements may be disclosed, the drawings may not be to scale.

The words “example,” or “exemplary,” when used herein, are intended to mean “serving as an example, instance, or illustration.” Any implementation described herein as an “example” or “exemplary embodiment” is not necessarily preferred or advantageous over other implementations.

### Overview

In the user experience (UX) design industry, a UX designer plays a crucial role in designing intuitive, engaging, and effective graphical user interfaces for users across various digital platforms, including websites, mobile applications, and software applications. Various software programs are widely used as tools in the field of UX design. The primary function of such software programs is to facilitate the creation of graphical user interfaces for websites and mobile applications. However, some software programs also support other related tasks. Various embodiments of the present disclosure include or are usable with a UX design software that utilizes a system of nested frames and/or layers, which enable designers to efficiently organize and manipulate parts (e.g., components) of a graphical user interface (e.g., components of the interface). In some instances, a frame may be a type of layer. For example, some embodiments of the present disclosure may be used in relation with and/or applied to software programs such as FIGMA, ADOBE XD, SKETCH, INVISION STUDIO, AFFINITY DESIGNER, GIMP, and/or the like.

The range of possible UX functionalities, geographical and experiential diversity of UX design teams, the rapid pace of UX software development, and other factors make detecting functionality or aesthetic issues with UX designs and enforcing UX guidelines and compliance standards difficult. Organizations may pair their UX teams with a dedicated compliance team responsible for overseeing UX designers and ensuring that parts of a graphical user interface adhere to various parameters such as established standards and guidelines. Such a compliance team would require experienced professionals with expertise in UX design, accessibility, legal requirements, and industry-specific regulations with sufficient bandwidth to review all UX designs created by the UX team. In some instances, the compliance engineer may not be immediately able to differentiate between two identical or seemingly identical UX components, one of which may be compliant while the other is not.

UX designers may be provided with a set of preapproved common components, such as buttons, links, form elements, and navigation structures. These preapproved components are designed to adhere to the various parameters. For example, the preapproved components may meet accessibility standards, branding guidelines, and technical specifications, ensuring consistency and usability across all products. Additionally, these preapproved components may serve as an automated basis for subsequent code conversion of approved graphical user interface designs. In addition to or instead of providing preapproved components, the compliance team may develop and maintain a comprehensive set of parameters covering various aspects of the UX design. These parameters may address issues such as color usage, typography, spacing, and interaction patterns. The compliance team may work closely with UX designers throughout the design process, reviewing graphical user interface proposals and prototypes to ensure compliance with established parameters and preapproved component usage. The compliance team may provide feedback and suggestions for improvement, helping UX designers refine their work to meet compliance parameters.

Preferably, UX designers should exclusively utilize preapproved components and/or remain within established parameters in graphical user interfaces, which may be swiftly approved. However, in practice, many graphical user interfaces necessitate ad-hoc solutions that require research and investigative work from UX designers, as well as custom components or modifications to preapproved components. Due to constraints such as time, inadequate training, or other factors, a UX designer may create a custom component when they should utilize preapproved components. For example, a custom made button may be configured such that is does not adhere to compliance parameters.

It is challenging to identify frames and/or layers in a graphical user interface that resemble a button component but are not from a preapproved set of components. For example, some undesirable approaches to the technical problems identified herein may include detecting when a component is sourced from another file or library, allowing for the identification of interfaces that utilize preapproved components. However, such undesirable approached necessitate that the component's structural elements have not been modified (e.g., the text on a button may be modified but the button's color or text style may not be modified if the component is still to be detected). Similarly, a purely visual analysis of the graphical user interface may be insufficient if the UX designer has recreated the visual appearance of a preapproved component with a custom component, which may lead to sub-optimal performance, integration or compatibility issues, or other problems in the future while the flaw remains undetectable from a purely visual review. Computer models that visually analyze the elements of an interface (e.g., computer vision models) may also be slow and bulky to operate. Currently, there are no tools available to detect similarities between components (e.g., as represented by frames and/or layers) in software programs according to embodiments of the present disclosure. Additionally, there is a need for determining compliance with parameters or the reusability of common, preapproved components within a graphical user interface.

By applying the component prediction system described herein, example embodiments may provide technical improvements by providing for the automatic identification of components comprising frames and/or layers that utilize preapproved components as well as detecting similarities between design elements to classify the various component or sub-component features (e.g., nodes representing frames or layers). In this manner, example embodiments provide technical improvements by providing for the automatic identification and classification of components, including preapproved components, components that have been structurally altered from a preapproved component, and/or custom made components. Various embodiments of the present disclosure provide a graph neural network capable of analyzing structured nature of graphical user interfaces along with their associated attributes (e.g., frame attributes) that overcome the technical limitations of manual analyses, purely vision-based analyses, or purely rules-based analyses. Certain techniques described herein enable the identification of components and may further update the identified components within a graphical user interface thereby enhancing UX design productivity, improving graphical user interface performance, and improving compliance of graphical user interfaces in a manner that computing systems lacking such techniques cannot.

Some embodiments of the present disclosure provide technical improvements to the field of UX design by providing a component prediction system that, by analyzing representations of the frames or layers in a graphical user interface, may automatically detect and identify particular components and generate updates to the graphical user interface based thereon. For example, the present disclosure includes various processes and corresponding apparatuses, systems, and computer program products for updating a graphical user interface, including by modifying or substituting one or more components in the graphical user interface for better performing and compliant interface components. Additionally, various embodiments of the present disclosure provide technical improvements to automating the graphical user interface design process, ensuring compliance with parameters, and facilitating subsequent code conversion. For example, certain embodiments of the present disclosure provide technical improvements by automatically identifying components and patterns in graphical user interfaces through the use of a graph neural network, which leverages the structure (e.g., nested tree structure) of frames and/or layers within a graphical user interface.

Some embodiments of the present disclosure provide technical improvements to the field of UX design by creating and training a graph neural network capable of detecting components based on graphical user interface information. For example, certain embodiments of the present disclosure provide technical improvements by utilizing information from a graphical user interface generated by a software program (e.g., FIGMA) which may be represented and exported as an interface design data object (e.g., as a file via the FIGMA REST API) to generate one or more updates to the graphical user interface.

Example embodiments may leverage various machine learning technologies described herein to generate updates to a graphical user interface and/or provide various capabilities configured to improve the review of graphical user interfaces for compliance with one or more parameters. Embodiments described herein may train one or more graph neural networks to receive input data objects associated with interface design data objects representative of graphical user interfaces and provide automatic updates to the graphical user interfaces based thereon. The system and embodiments disclosed herein may provide techniques for generating training data in an efficient and integrated manner using software programs. Accordingly, embodiments described herein provide techniques for generating training data and applying machine learning technologies described herein for natively processing representations of graphical user interfaces (e.g., interface design data objects) to analyze and automate review of graphical user interfaces that computing systems lacking such techniques cannot.

In some embodiments, the machine learning processes (e.g., the graph neural network) may run in real time or near real time on graphical user interfaces or portions thereof. In some embodiments, the machine learning processes (e.g., the graph neural network) may analyze a graphical user interface at various intervals (e.g., periodically, such as daily) and/or upon receipt of a trigger (e.g., a manual prompt for review, a submission of the UX code, and/or other milestones and trigger conditions). Additionally, embodiments described herein provide technical improvements to the technical field of UX design by providing systems with improved reusability of components compared to other systems. For example, updates to a graphical user interface may automatically replace an identified component with a similar preapproved component or otherwise suggest a preapproved component to replace an identified component within a graphical user interface, thereby promoting the reusability of common, preapproved components within a graphical user interface.

Various technical improvements will be appreciated from the present disclosure. For example, example embodiments of the present disclosure receive an interface design data object, the interface design data object comprising a text-based representation of each a graphical user interface. Various example embodiments described herein may generate an input data object based on the interface design data object, the input data object representing the plurality of frames or layers as a plurality of nodes related to each other based on the data indicating the at least one parent or child node, apply the input data object to a graph neural network configured to generate at least one predicted classification associated with at least one of the plurality of nodes, and, based on the at least one predicted classification, generate an update to the graphical user interface.

The embodiments described herein may automatically receive an interface design data object and generate updates to an associated graphical user interface based thereon. In this regard, embodiments of the present disclosure improve the technological field of UX design and determining compliance of graphical user interfaces at least by providing updates to graphical user interfaces that may modify the graphical user interfaces and/or are accessible to users via a display device which obviates the need for users to, for example, manually revise attributes of the frames or layers of a graphical user interface. This, in turn, reduces human resources and time costs associated with reviewing graphical user interfaces and standardizes and expediates graphical user interface review processes. Embodiments of the present disclosure further provide technical improvements by training machine learning models for natively handling data representative of graphical user interfaces and leveraging the trained machine learning models and specially configured framework to generate updates to graphical user interfaces.

Embodiments of the present disclosure may further provide technical improvements in the field of UX design by at least (i) applying an input data object to a graph neural network configured to generate at least one predicted classification, and/or (ii) generating an update to a graphical user interface. Embodiments of the present disclosure further provide technical improvements in the field of UX design by promoting the reuse of preapproved component within graphical user interfaces which, with the aforementioned systems and processes, allow for improved compliance and consistency in graphical user interfaces. Furthermore, by training graph neural networks as described above, embodiments of the present disclosure facilitate various capabilities including the automatic analysis and/or identification of frames and/or layers representing components within graphical user interfaces. Embodiments of the present disclosure may be used in a plurality of domains, applications, environments, and/or architectures and are not limited to any specific domain, application, environment, and/or architecture.

### Definitions

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data object,” or “data set” refer interchangeably to data capable of being transmitted, received, and/or stored.

As used herein, the term “machine learning model” refers to one or more processes, algorithms, and/or other data entity that describes parameters, hyper-parameters, defined operations, and/or defined mappings of a model that is configured to process one or more inputs in accordance with one or more trained parameters of the machine learning models in order to generate a prediction. An example of a machine learning model is a mathematically derived algorithm (MDA). An MDA may comprise any algorithm trained using training data to predict one or more outcome variables. Without limitation, an MDA, as used herein, may comprise machine learning frameworks including neural networks, diffusion models, generative adversarial networks, convolutional neural networks, recurrent neural networks, text-to-video models, video-to-text models, text-to-speech models, speech-to-text models, large language models, generative pre-trained transformers (GPT), support vector machines, gradient boosts, Markov models, adaptive Bayesian techniques, and statistical models (e.g., timeseries-based forecast models such as autoregressive models, autoregressive moving average models, and/or an autoregressive integrating moving average models). Additionally, and without limitation, an MDA, as used in the singular, may include ensembles using multiple machine learning and/or statistical techniques.

As used herein, the term “graphical user interface” refers to a representation of a software interface. For example, a graphical user interface may be the visual representation of a software such as a website, mobile application, desktop application, and/or the like, that may be used to generally interface with the software. By way of example, images, buttons, links, backgrounds, text fields, and/or the like, may be included within and/or make up a graphical user interface. In some examples, a graphical user interface may be made up of and/or otherwise include one or more frames and/or layers, which may be organized into interface components. In some examples, a graphical user interface may be represented by an interface design data object. A graphical user interface may be configured for display on one or more screens (e.g., a screen of a mobile phone, a personal computer, or the like).

In some embodiments, a user experience (UX) designer may generate a graphical user interface. In some examples, a graphical user interface may be generated using one or more software programs. For example, the programs: FIGMA, ADOBE XD, SKETCH, INVISION STUDIO, AFFINITY DESIGNER, ADOBE PHOTOSHOP, and/or the like, may be used to generate, design, manipulate, represent, export, and/or the like, graphical user interfaces. In some examples, such a software program may generate a graphical user interface according to a layered structure of frames and/or layers (e.g., nested frames). In an example, a back end of a software program used to generate a graphical user interface, may represent the graphical user interface as an interface design data object. In another example, a software program used to generate a graphical user interface may export (e.g., via an API) a representation of at least a portion of a graphical user interface as an interface design data object. In this manner, a graphical user interface may be transmitted, modified, analyzed, rendered, represented, and/or the like, by an interface design data object. In some examples, a graphical user interface may be associated with one or more compliance parameters. For example, a graphical user interface may be compared (e.g., via the component prediction system or UX logic engine) against one or more compliance parameters to determine whether the graphical user interface adheres to the one or more compliance parameters.

As used herein, the term “component” refers to a data entity that may be a portion of a graphical user interface. Accordingly, in some examples, a component may be a building block of a graphical user interface. For example, a graphical user interface may include one or more components that represent one or more portions, attributes, functionalities, and/or the like, and make up the graphical user interface or one or more portions thereof. By way of example, a component may be a button, a text field, an icon, a background, a header, a footer, and/or the like. A component may include, for example, one or more frames that make up the component and/or one or more layers that make up the component. A component may include various attributes defining the visual appearance (e.g., size, shape, color, placement within the interface, etc.) and/or function of the component. In various examples, a component may be generated, modified, reused, analyzed, and/or the like. In some examples, a component may be associated with one or more compliance parameters. For example, a component may be compared (e.g., via the component prediction system or UX logic engine) against one or more compliance parameters to determine whether the component adheres to the one or more compliance parameters.

As used herein, the term “frame” refers to a data entity that may be a portion of a component and/or graphical user interface. A frame may be a type of layer. For example, within the FIGMA software program, a frame may represent an element of a graphical user interface that acts as a container or area in which a component may be defined. A frame may include various layers and associated attributes. For example, a frame may be a layer that acts as a container to organize other layers (e.g., shapes, images, text, etc.). Frames may sit on a canvas or other top level region. Frames having other layers within them are “parent frames” and frames within other frames are “child frames”. Accordingly, in some examples, a frame may be a building block of a component and/or graphical user interface. For example, a component and/or a graphical user interface may include one or more frames that make up the component and/or graphical user interface or one or more portions thereof. By way of example, a frame may be a defined area or region of the graphical user interface that may be associated with one or more attributes, data objects, and/or the like. In some examples, a frame may be associated with one or more other frames according to a structure, relationship, and/or the like. For example, a one frame (e.g., a child frame) may be nested within another frame (e.g., a parent frame). In some examples, a child frame may be in a lower (or higher) hierarchical location as compared to a parent frame of the child frame within a structure associated with a graphical user interface. Additionally or alternatively, a child frame may be lower (or higher) as compared to a parent frame of the child frame within a hierarchical representation (e.g., a tree structure, graph structure, etc.) of the graphical user interface. In some examples, a structure according to which frames are associated with each other may be defined by one or more constraints, rules, and/or the like. For example, one or more frames may be associated with each other via one-to-one parent-child relationships (i.e., a frame may have only one parent frame and/or one child frame). Such a structure may be explicitly stored as part of the frame or in association with the frame or may be inherently derived from a graphical user interface and/or interface design data object. In some examples, a frame may be associated with one or more compliance parameters. For example, a frame may be compared (e.g., via the component prediction system or UX logic engine) against one or more compliance parameters to determine whether the frame adheres to the one or more compliance parameters.

As used herein, the term “layer” refers to a data entity that may be a portion of a component and/or graphical user interface. Layers may be the foundational elements that make up a graphical user interface, which layers may be organized into various groups (e.g., frames and/or nested layers) to define components. In some embodiments, each frame and/or an entire graphical user interface may include one or more layers. Some graphical user interfaces may use only layers without frames. In some examples, a layer may be associated with one or more other layers or frames according to a structure, relationship, and/or the like. For example, a one layer (e.g., a child layer) may be nested within another layer (e.g., a parent layer). In some embodiments, layers may include attributes that define the appearance of the layer. For example, a layer order attribute may define how layers overlap within a frame or the graphical user interface as a whole. Within the graphical user interface analyses discussed herein, frames and/or layers may be represented as nodes in a tree structure (e.g., root nodes, leaf nodes, etc.) for analysis by a graph neural network. In some embodiments, the frames and other layers may be used interchangeably by the processes described herein. For example, frames and other layers may each be considered “nodes” for use with a graph neural network and related processes described herein. In some embodiments, a subset of the available frames and/or other layers may be used.

As used herein, the term “interface design data object” refers to a data object including data representative and/or otherwise associated with one or more graphical user interfaces. An interface design data object may include structured data, for example, a structured dataset including text-based representations of a graphical user interface (e.g., frames and/or layers, attributes such as positions, font color, bounding boxes, visibility, names, etc., relationships such as lists of children and/or parents, etc.). By way of example, an interface design data object may be a data object (e.g., . JSON file) that describes, represents, and/or the like, at least a portion of at least one graphical user interface.

In some embodiments, data of an interface design data object may be used to represent the interface design data object as a tree structure, graph structure, and/or the like. For example, each frame and/or layer of an interface design data object may correspond to a node and each relationship among the frames and/or layers of an interface design data object may correspond to an edge to be used to generate a tree structure, graph structure, and/or the like, representing the structure of the graphical user interface. Accordingly, such nodes and edges may be used to generate a tree structure, graph structure, and/or the like, where each node represents a frame and/or layer, and each edge represents a relationship between frames and/or layers. As used herein, the terms “node” may be used interchangeably with “frame” and/or “layer” unless noted otherwise, the terms “edge” and “relationship” or “parent-child relationship” may be used interchangeably, the terms “component”, “sub-graph”, “graph”, “sub-tree”, or “tree” may be used interchangeably, and the terms “attribute” or “feature” may be used interchangeably.

As used herein, the term “input data object” refers to a data object generated based on at least a portion of at least an interface design data object and configured to be input to a graph neural network. The input data object may be a computer-readable data object defined in a format readable as an input to a machine learning model (e.g., a graph neural network). In some examples, an input data object may include one or more matrices. For example, an input data object may include a node features matrix (e.g., a matrix representing frames and/or layers having attributes as nodes having features) and an adjacency matrix (e.g., a matrix representing relationships between frames and/or layers as edges). In some examples, an input data object may include one or more other and/or additional matrices such as an edge features matrix (e.g., a matrix representing edges having features), a combined matrix (e.g., a node features matrix and an adjacency matrix represented as one matrix), and/or the like. In various examples, an input data object may include one or more data structures configured for input to a graph neural network that are not matrices (e.g., graph data objects, lists of features, tensors, etc.).

By way of example, a matrix (e.g., a node features matrix, adjacency matrix, etc.) may include vectorized representations of corresponding data. For example, consider a node feature matrix including a plurality of nodes representative of a plurality of frames and/or layers. In such an example, the node feature matrix may include a plurality of rows (i.e., nodes) and columns (i.e., features) where each row is representative of a frame and/or layers and each column is representative of an attribute of the respective frame/layer. Accordingly, each row includes a plurality of values corresponding to each column such that the node feature matrix includes vectorized representations of frames and/or layers having attributes as nodes having features.

In another example, an adjacency matrix may include a plurality of nodes representative of a plurality of frames and/or layers. In such an example, the adjacency matrix may include a plurality of rows (i.e., nodes) and columns (i.e., the same nodes) where each row is representative of one respective frame or layer of a plurality of frames or layers and each column is representative of another frame or layer of the same plurality of frames and/or layers. Accordingly, each row (or column) includes a plurality of values corresponding to whether the respective pair of nodes have a relationship such that the adjacency matrix includes vectorized representations of the relationships between nodes (e.g., a value of 1 if the respective pair of nodes have a parent-child relationship and a value of 0 otherwise).

As used herein, the term “component prediction system” refers to one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to receive, process, and/or generate, interface design data objects, input data objects, predicted classifications, updates to graphical user interfaces, and/or the like. For example, in some embodiments, the component prediction system may include a graph neural network.

In some embodiments, the component prediction system may include one or more rules-based algorithms and/or machine learning models. For example, the component prediction system may include one or more data ingestion engines, graph neural networks, UX logic engines, and/or the like. In some examples, the component prediction system may receive (e.g., via a data ingestion engine) an interface design data object (e.g., to generate an input data object using the data ingestion engine). In some examples, the component prediction system may receive an input data object. In some examples, the component prediction system may retrieve (e.g., via the data ingestion engine) an interface design data object using a file key, URL, and/or the like. In some examples, the component prediction system may generate (e.g., via a data ingestion engine) an input data object based on an interface design data object. In some examples, the component prediction system may generate (e.g., via a graph neural network) one or more predicted classifications based on an input data object. In some examples, the component prediction system may generate (e.g., via a UX logic engine) one or more updates to a graphical user interface based on one or more predicted classifications.

As used herein, the term “data ingestion engine” refers to one or more processes, algorithms, and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to receive interface design data objects and generate input data objects. By way of example, a data ingestion engine may include program code configured to parse an interface design data object (e.g., a .JSON file output from a particular software used for generating graphical user interfaces) and transform the interface design data object into an input data object configured to be input to a graph neural network. In some examples, the data ingestion engine may identify data representative of nodes and attributes within an interface design data object and generate a matrix (e.g., generate vectorized representations of frames and/or layers and their attributes to generate a node feature matrix) based on the identified data. Additionally or alternatively, in some examples, the data ingestion engine may identify data representative of relationships between nodes within an interface design data object and generate a matrix (e.g., generate vectorized representations of the relationships between nodes to generate an adjacency matrix) based on the identified data. In various examples, the data ingestion engine may be configured to generate any input data object based on an interface design data object such that the input data object is configured to be input to a graph neural network.

In some embodiments, the data ingestion engine may be configured to retrieve an interface design data object. For example, the data ingestion engine may receive a file key, a URL associated of an interface design data object, and/or the like such that the data ingestion engine may query an API (e.g., a REST API of a software used to generate graphical user interfaces such as the Figma API) to retrieve an interface design data object.

As used herein, the term “graph neural network” refers to a data entity that describes parameters and/or hyper-parameters and/or defined operations of a machine learning model (e.g., model including at least one of one or more rule-based layers, one or more layers that depend on trained parameters, coefficients, and/or the like) configured to process graph-based data such as input data objects and generate one or more predicted classifications. In some examples, a graph neural network may include a graph convolutional network (GCN) (e.g., any N-layer GCN such as a single-layer GCN, a two-layer GCN, three-layer GCN, a five-layer GCN, etc.), graph attention network (GAT), graph sample and aggregation (SAGE) network, graph isomorphism network (GIN), message passing neural network (MPNN), any other graph neural network architecture, and/or the like.

In various embodiments, a graph neural network may be trained for various prediction-based tasks. For example, a graph neural network may be trained to perform node-level classifications (e.g., node classification, edge prediction etc.), graph-level classifications (e.g., graph classification, etc.), and/or the like. In some examples, a graph neural network may be trained for multi-task learning and perform two or more prediction-based tasks (e.g., node-level classifications and graph-level classifications) sequentially and/or in parallel. In some examples, a common graph neural network may be used for different tasks based on different architectures (e.g., different final dense layers respective to node-level classification, graph-level classification, edge prediction, etc.).

In some embodiments, a graph neural network may be trained using training data configured for a respective task. For example, a graph neural network may be configured for a particular one or more tasks and then trained using corresponding training data via a backpropagation mechanism using a loss function (e.g., cross-entropy loss) to train the graph neural network to, for example, provide a correct classification to each node of an input data object.

In at least an example, the training data may include at least a dataset of components. The components may be included, for example, in a library of preapproved components (e.g., components that are preapproved for a particular UX application based on compliance parameters). A graph neural network trained on such training data may be, for example, trained to perform graph classification and/or graph similarity detection tasks. Each subtree derived from graphical user interface may be used as an input to such a graph neural network and the graph neural network may, for example, generate an embedding for each input (e.g., by averaging all features of each vector of an output). Each embedding may then, for example, be compared with embeddings of the preapproved components of the training data to assign a detected classification to the input. In such an example, a methodology (e.g., a voting system among parent-child nodes to assess which node is most suited to be a root node of a detected component) may be used to determine a correct depth in a tree structure when assigning a specific component classification.

In at least an example, the training data may include at least a dataset of labeled components. For example, one or more interface design data objects may be labeled to indicate particular frames and/or layers associated with components (e.g., labeling nodes with root classifications, component classifications, etc.). A graph neural network trained on such training data may be, for example, trained to perform node-level classification and/or subtree classification. For example, the graph neural network may generate a predicted root classification for each node (e.g., indicating a node as a root of a component or not a root of a component). Additionally or alternatively, in some examples, the graph neural network (e.g., trained via multi-task learning) may generate a predicted component classification (e.g., for each node, for each node classified as a root, for each subtree indicated by each node classified as a root, etc.). Additionally or alternatively, in some examples, another graph neural network, or an alternative architecture of the graph neural network, may be applied to generate a predicted component classification.

In at least an example, the graph neural network may include a two-layer GCN as a primary architecture. In such an example, the main forward function of the architecture may be represented by Z=f(X,A)=SoftMax(ÂReLu(ÂXW⁽⁰⁾)W⁽¹⁾) where A may be an adjacency matrix (e.g., typically scaled), representing edges between nodes (e.g., parent-child relationships between frames and/or layers) of a graph. In some examples, a bottom-up directed graph representation may be used. For example, such a bottom-up directed graph representation may facilitate the upward transmission of node information to its parent and subsequently to its ancestors. In other examples, any N-layer GCN may be used or any other graph neural network architecture.

In the above example, X may represent a feature vector matrix that contains a set (e.g., vector) of features (e.g., information such as attributes of nodes) for each node. In some examples, each attribute (e.g., a color, type of node, etc.) available in a graphical user interface design layer (e.g., a Figma layer) may be converted into one or more features that are, for example, numerical or categorical. In various examples, other textual features may be encoded using a textual model (e.g., an embedding model), configured to convert the textual features into one or more vectors of values (e.g., embeddings). In other examples, all textual features may be aggregated and encoded into a single vector (e.g., embedding).

In the above example, W⁰ and W¹ may represent trainable weights matrices of the two layers, respectively. The output, Z may represent a matrix of size N by F, including an embedding vector of size F for each of the N nodes. In some examples, the last W layer may be size F where F is the number of components being detected in a node classification or subtree classification task. In various examples, one or more additional dense (e.g., fully connected) layers may be added after the above described GCN to provide a classification (e.g., a component classification, root classification, etc.) for each node. In an example where the graph neural network is used for graph classification or graph similarity detection tasks, an entire input graph may be embedded into a single vector by averaging the features of all N vectors in the output Z to obtain a single vector of size F. Using such a single vector (e.g., embedding), the input graph may be compared (e.g., using a similarity score, a confidence threshold, etc.) with a vector of a known graph (e.g., an embedding of a preapproved component) to generate a predicted classification (e.g., a component classification).

As used herein, the term “predicted classification” refers to an output of a graph neural network. In various examples, a predicted classification may include one or more numerical variables, categorical variables, embeddings, confidence scores, and/or the like. In some examples, a predicted classification may include a node-level classification such as a node classification, a root classification, a component classification, a node embedding, and/or the like. In some examples, a predicted classification may include a graph-level classification such as a graph classification, a sub-graph classification, a component classification, a graph embedding, and/or the like. In some examples, a predicted classification may be provided to the UX logic engine and used to generate an update to a graphical user interface.

As used herein, the term “component classification” refers to a data entity that may indicate information associated with a component. For example, a component classification may indicate one or more layers, frames, nodes, subtrees, subgraphs, and/or the like, are associated with a particular component. Additionally or alternatively, in some examples, a component classification may indicate one or more layers, frames, nodes, subtrees, subgraphs, and/or the like, are not associated with a particular one or more components (e.g., a component that is unknown and/or is not similar to any preapproved components). In some examples, a component classification may indicate what a particular component is, such as a button, a header, a footer, and/or the like. Additionally or alternatively, in some examples, a component classification may indicate a particular component satisfies or fails to satisfy one or more compliance parameters. In some examples, a component classification may be associated with a predicted classification. For example, a predicted classification may indicate a particular component classification, an embedding associated with a particular component classification, a confidence score associated with a particular component classification (e.g., as compared to a confidence threshold), and/or the like, for a respective one or more inputs.

As used herein, the term “root classification” refers to a data entity that may indicate information associated with a node. For example, a root classification may indicate that a node is a root node of a component. Additionally or alternatively, in some examples, a root classification may indicate that a node is not a root node of a component. In some examples, a root classification may be associated with a predicted classification. For example, a predicted classification may indicate a particular root classification, an embedding associated with a root classification, a confidence score associated with a root classification, and/or the like, for a respective one or more nodes. As used herein, the term “root” refers to a node that is the starting point for a component represented by a tree or graph structure. For example, a root node may be a node included within a component such that the root node has no parent node that is also included within the same component. As another example, a root node may correspond to a frame or layer that is included within a component and also includes all other frames and/or layers included within the same component.

As used herein, the term “UX logic engine” refers to one or more processes, algorithms, and/or other data entity that describes parameters, hyper-parameters, and/or defined operations of a rules-based algorithm and/or other data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like configured to receive interface design data objects and generate updates to a graphical user interface. For example, the UX logic engine may be configured to receive one or more predicted classifications and generate one or more updates to a graphical user interface based on the one or more predicted classifications.

As used herein, the term “update to a graphical user interface” or the like refers to a data object that may be or otherwise include a notification, indicator, flag, list, update, and/or the like associated with a layer, frame, component, graphical user interface, and/or the like. In some examples, the UX logic engine may be configured to indicate, list, update and/or the like, components associated with predicted classifications via updates to a graphical user interface.

In an example, a component of a graphical user interface may be associated with a predicted classification where the predicted classification indicates that the component is not identified as a preapproved component. In such an example, an update to the graphical user interface may be used to indicate the component needs review, the component needs to be updated, the component needs to be replaced, and/or the like. In another example a component of a graphical user interface may be associated with a predicted classification where the predicted classification indicates that the component is identified as a preapproved component. In such an example, an update to the graphical user interface may be used to indicate the component does not need review.

In this manner, in various examples, updates to a graphical user interface may be used to indicate, flag, list, and/or the like, components which are or are not identified as preapproved components, components which do or do not need review, components which do or do not meet one or more compliance parameters, and/or the like. Additionally or alternatively, in some examples, an update to a graphical user interface may suggest a preapproved component to be used in place of a component associated with a predicted classification. Additionally or alternatively, an update to a graphical user interface may automatically replace a component associated with a predicted classification with a preapproved component. Additionally or alternatively, in some examples, an update to a graphical user interface may indicate one or more attributes of a component associated with a predicted classification which fail to meet one or more compliance parameters. For example, an update to a graphical user interface may indicate that an incorrect font was used within a component associated with a predicted classification based on one or more compliance parameters. In some embodiments, the update to a graphical user interface may include replacing one component with another. In some embodiments, the replacement component may adopt one or more attributes of the original (e.g., replaced) component.

As used herein, the term “compliance parameter” refers to a data object indicative of one or more parameters used to define attributes and/or criteria of a layer, frame, component, interface design data object, and/or graphical user interface. For example, a layer, frame, component, interface design data object, and/or a graphical user interface associated with a business may be required to meet one or more compliance parameters the business has defined such as the fonts, colors, styles, positioning, layout, and/or the like, used in order to meet accessibility standards, branding guidelines, technical specifications, and/or the like, associated with the business.

### System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., user devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps.

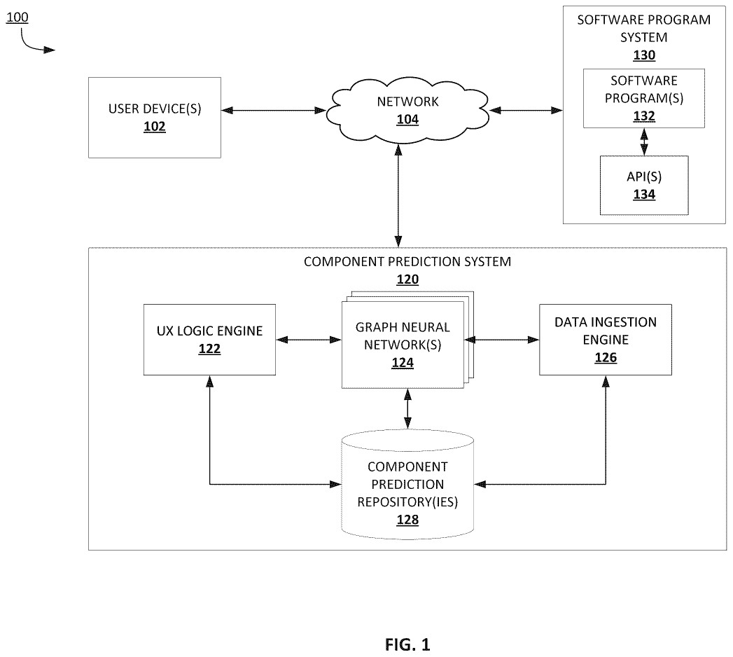

In this regard, FIG. 1 shows an example system environment 100 within which at least some embodiments of the present disclosure may operate. The depiction of the example system environment 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the system environment 100 disclosed therein is merely presented to provide an example basis and context for the facilitation of some of the features, aspects, and uses of the methods, apparatuses, computer readable media, and computer program products disclosed and contemplated herein.

With reference to FIG. 1, the depicted example system environment 100 includes a component prediction system 120, one or more user devices 102, and one or more software program systems 130, which may communicate via the network 104. The component prediction system 120 includes the UX logic engine 122, one or more graph neural networks 124, the data ingestion engine 126, and one or more component prediction repositories 128, configured to perform one or more functionalities of the component prediction system 120. The software program system includes one or more software programs 132 and APIs 134 configured to perform one or more functionalities of the software program system 130. The one or more user devices 102, component prediction system 120, and software program system 130 may communicate via the network 104.

It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components. For example, in some embodiments, the functions of one or more of the illustrated components in FIG. 1 may be performed by a single computing device or by multiple computing devices, which devices may be local or cloud based. It will be appreciated that the various functions performed by one or more of the component prediction system 120, the user device(s) 102, or the software program systems 130, may be embodied by a single apparatus, subsystem, or system comprising one or more sets of computing hardware (e.g., processor(s) and memory) configured to perform various functions thereof.

In some embodiments, the component prediction system 120 may be configured to provide a platform, such as a mobile application platform and/or a web application platform for access by a user. In this regard, the mobile application platform may be accessed by a user device 102 via an application installed in the user device 102. Further, the web application platform may be accessed by a user device 102 via a web browser, mobile browser application (e.g., a Wireless Application Protocol browser), and/or the like. In some embodiments, the component prediction system 120 or portions thereof (e.g., one or more components of the component prediction system 120) may be embodied by and/or executed via a user device 102. For example, one or more software packages may be downloaded to a user device 102 and configured to perform the functions of one or more components of component prediction system 120 via a memory and/or processor of the user device 102. In some embodiments, the component prediction system 120 or portions thereof (e.g., one or more components of the component prediction system 120) may be embodied by one or more portable data storage devices, one or more platforms (e.g., mobile application platform, web application platform, etc.), and/or some combination thereof. Similarly, in some embodiments, the software program system 130 or portions thereof (e.g., one or more software programs 132 or APIs 134) may be embodied by and/or executed via a user device 102.

In some embodiments, a user device 102 is electronic computing device that may be used by a user for any of a variety of purposes including, but not limited to, one or more of sending and/or receiving signals, storing data, displaying data, viewing data, or initiating predictive computing task(s). For example, the user device 102 may be capable of, but not limited to, one or more of displaying graphical user interfaces and other graphical representations on the screen of the user device 102, receiving user input that triggers predictive classification computing task(s), determining and/or receiving update data that triggers dynamic update of a screen of the user device 102 and/or information displayed on the screen of the user device 102, or delivering graphical user interfaces or other graphical representations to a user device or other computing device.

A user device 102 may include computer hardware and/or software configured to perform one or more functionalities associated with the user device(s) 102 described herein. In some embodiments, the user device 102 may be a mobile device. The mobile device may be a user device that is capable of being held and transported by a user. Example mobile devices include, but not limited to, smart phones, tablet computers, laptop computers, wearables, laptop computers, components or devices interacting with such devices (e.g., web cams, microphones, etc.), or the like. In some embodiments, the user device 102 may be a personal computer or terminal usable for interacting with the component prediction system 120 and/or software program system 130 (e.g., via the network and/or direct communication). In various embodiments, a user device 102 may be a device owned by or otherwise assigned to the user (e.g., a personal mobile phone, tablet, laptop, desktop computer, components or other related devices, etc.). The user device 102 may use (e.g., access and/or install) one or more computer program products (e.g., a mobile application platform, desktop computer application platform) configured to provide one or more functionalities of the component prediction system 120 or software program system 130. In some embodiments, one or more computer program products configured to provide one or more functionalities of the component prediction system 120 may be configured in association with a type of the user device 102 and/or operating system the user device 102. For example, the user device 102 using an application configured to provide one or more functionalities of the component prediction system 120 may be a smartphone using a mobile application, a program installed on a personal computer, a web browser or other temporarily loaded software functionality, or the like; a desktop computer using a desktop application; and/or the like. In various embodiments, a computer program product configured to provide one or more functionalities of the component prediction system 120 may be configured to operate with one or more types of user devices 102 and/or one or more operating systems.

In some embodiments, the component prediction system 120 may include one or more of a UX logic engine 122, a data ingestion engine 126, or one or more component prediction repositories 128. In the illustrated system environment of FIG. 1, the software program systems 130 include the software programs 132 and the APIs 134. The software program systems 130 may, for example, include one or more computing devices, servers, computer program products, and/or the like configured to provide access to and/or facilitate performance of one or more functionalities of the software programs 132 and/or the APIs 134. Additionally or alternatively, the software programs 132 may be implemented by one or more computing devices, servers, computer program products, and/or the like. For example, a software program system 130 may be embodied in a cloud server configured to provide access to a software program 132 and corresponding APIs 134 accessible to a user device 102 and/or the component prediction system 120 via the network 104.

In some embodiments, a software program system 130 may be accessible (e.g., via network 104) to provide a software program 132 for install and/or use at a user device 102 such that the user device 102 includes the software program 132 as a computer executable program. In such an example, the software program system 130 may provide access to an API 134 hosted by the software program system 130 where the API 134 is configured to perform one or more functionalities associated with the software program 132 installed on the user device 102 (e.g., retrieving an interface design data object associated with a graphical user interface generated via the software program 132 at the user device 102). Additionally or alternatively, the API 134 may be included within or alongside the software program 132 installed on the user device 102. In some embodiments, one or more software program systems and/or software programs may be accessed (e.g., via the network) by the user device(s) to support the functionalities thereof.

In some embodiments, the component prediction repositories 128 may be configured to store various data for the component prediction system 120. For example, one or more component prediction repositories 128 may be configured to store training data for training one or more graph neural networks 124, graphical user interfaces, interface design data objects, file keys and/or URLs associated with graphical user interfaces and/or interface design data objects, input data objects, predicted classifications, updates to graphical user interfaces, and/or the like. The component prediction repositories 128 may be configured to provide or otherwise make available various data stored within to the various components of the component prediction system 120. Additionally or alternatively, the component prediction repositories 128 may be configured to store or otherwise make available various data associated with the user devices 102 or software program system 130. Additionally or alternatively, the component prediction repositories 128 may store or otherwise make available one or more of the graph neural networks 124.

In some embodiments, the component prediction system 120 or one or more components thereof may be accessed by a user device 102 (e.g., via the network 104). In various embodiments, the component prediction system 120 or one or more components thereof may be a computer executable program and installed at the user device 102. In this manner, in some embodiments, the functions of one or more of the illustrated devices, systems, and/or components of the system environment 100 may be performed by a single computing device or by multiple computing devices, which devices may be local or cloud based.

The various functions of the component prediction system 120 and system environment 100 may be performed by other arrangements of one or more computing devices and/or computing systems without departing from the scope of the present disclosure. In some embodiments, a computing system may comprise one or more computing devices (e.g., server(s)). For example, in an embodiment, one or more functions of the user device 102, software program systems 130, or component prediction system 120 may be performed by a single computing device, computing system, or server. In some embodiments, the functions of one or more of the illustrated components of the component prediction system 120 may be performed by a single computing device or by multiple computing devices, which devices may be local or cloud based. It will be appreciated that the various functions performed by two or more of the UX logic engine 122, graph neural networks 124, data ingestion engine 126, or component prediction repositories 128 may be performed by a single apparatus, subsystem, or system. For example, two or more of the UX logic engine 122, graph neural networks 124, data ingestion engine 126, or component prediction repositories 128 may be embodied by a single apparatus, subsystem, or system comprising one or more sets of computing hardware (e.g., processor(s) and memory) configured to perform various functions thereof.

The various components illustrated in the component prediction system 120 and system environment 100 may be configured to communicate via one or more communication mechanisms, including wired or wireless connections, such as over a network, bus, or similar connection. For example, a network may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network may include a cellular telephone, an 802.11, 802.16, 802.20, and/or WiMAX network. Further, a network may include a public network, such as the Internet, a private network, such as an intranet, or combinations thereof, and may utilize a variety of networking protocols now available or later developed including, but not limited to TCP/IP based networking protocols.

In various embodiments, the components depicted in FIG. 1 as being included in the component prediction system 120, although not required to be an integral system, may be connected via one or more networks. In some embodiments, one or more APIs may be leveraged to communicate with and/or facilitate communication between one or more of the components illustrated in the component prediction system 120 and system environment 100 (e.g., APIs 134).

### Example System Operation

Using the various components and techniques described herein, the component prediction system 120 may be configured to receive an interface design data object. For example, the component prediction system 120 may receive an interface design data object from a user device 102 (e.g., a UX designer computing device, a compliance engineer computing device, or another device) or a software program system 130 (e.g., a software repository, coding platform, or the like) via the network 104. In an example, the user device 102 may generate (or be used to generate) a graphical user interface and a corresponding interface design data object via the software program system 130. In such an example, the user device 102 may obtain the interface design data object and provide the interface design data object to the component prediction system 120 (e.g., via the network 104). In another example, the user device 102 may cause the software program system 130 to provide the interface design data object (e.g., via an API 134, such as retrieving a . JSON file via a REST API) to the component prediction system 120. In some embodiments, the component prediction system 120 may communicate with the software program system 130 directly (e.g., via the network and API 134 without communicating through the user device). In some such embodiments, the user device may trigger the communication between the component prediction system 120 and the software program system 130.

In some examples, the component prediction system 120 may receive data associated with the interface design data object. For example, the component prediction system 120 may receive data associated with the interface design data object from the user device 102 or the software program system 130 via the network 104, and the component prediction system 120 may use the data associated with the interface design data object to receive the interface design data object. For example, the component prediction system 120 may receive a file key or URL associated with the interface design data object from the user device 102 or the software program system 130. In some examples, the component prediction system 120 may query the API 134 using the file key or URL associated with the interface design data object to receive the interface design data object. In some examples, the component prediction system 120 may receive the interface design data object via the data ingestion engine 126.

In various embodiments, the component prediction system 120 may be configured to generate an input data object. For example, the component prediction system 120 may generate an input data object based on the interface design data object. In some examples, the component prediction system 120 may generate the input data object via the data ingestion engine 126.

In some embodiments, the component prediction system 120 may be configured to generate at least one predicted classification. For example, a graph neural network 124 may be configured to receive the input data object and generate one or more predicted classifications based on the received input data object. Accordingly, the component prediction system 120 may apply the input data object to a graph neural network 124 configured to generate at least one predicted classification.

In various embodiments, the component prediction system 120 may be configured to train a graph neural network 124. For example, the component prediction system 120 may train a graph neural network 124 for a particular prediction-based task (e.g., generating a predicted classification) using training data configured for the particular prediction-based task. In some examples, the graph neural network 124 may be trained for node-level classification tasks, graph-level classification tasks, and/or the like. In various examples, the component prediction system 120 may include a plurality of graph neural networks 124 where each graph neural network of the plurality of graph neural networks 124 is trained for a particular prediction-based task (e.g., one graph neural network trained for a particular node-level classification and another graph neural network trained for a particular graph-level classifications). Additionally or alternatively, one or more graph neural networks 124 may be trained for multi-task learning and perform a plurality of prediction-based tasks (e.g., one graph neural network trained for one or more node-level classification tasks and one or more graph level classification tasks). Additionally or alternatively, one or more graph neural networks 124 may be used for a plurality of prediction-based tasks based on various architectures of the graph neural network 124 (e.g., different final dense layers for different classification tasks). In some embodiments, the system may include an ensemble of graph neural networks 124, each having a specific subset of one or more prediction-based task(s) (e.g., identifying one or more predictable components of a plurality of predictable components). Additionally or alternatively, a single graph neural network 124 may be trained to perform one or more of the plurality of prediction-based tasks as described herein. For example, a single graph neural network 124 may be configured to perform all prediction-based tasks associated with the system (e.g., identifying all predictable components).

In various embodiments, the component prediction system 120 may be configured to generate an update to a graphical user interface. For example, the component prediction system 120 may generate the update to a graphical user interface based on at least one predicted classification. In some examples, the component prediction system 120 may generate an update to a graphical user interface via the UX logic engine 122.

In some embodiments, the component prediction system 120 may provide or otherwise cause an update to a graphical user interface to a user device 102 or software program system 130. For example, the component prediction system 120 may transmit an update to a graphical user interface to a user device 102 or software program system 130 via the network 104. In some examples, the component prediction system 120 may provide an update to a graphical user interface via the UX logic engine 122.

In some embodiments, one or more components of the component prediction system 120 may be communicatively coupled. For example, the data ingestion engine 126 may receive an interface design data object and, in response, generate an input data object and provide the input data object to a graph neural network 124. The graph neural network 124 may, for example, in response to receiving an input data object, generate at least one predicted classification and provide the at least one predicted classification to the UX logic engine 122. The UX logic engine 122 may, for example, in response to receiving at least one predicted classification, generate an update to a graphical user interface and provide the update to the graphical user interface to a user device 102 and/or software program system 130.

In some embodiments, various data associated with the component prediction system 120 may be stored and/or otherwise made available for later use via the one or more component prediction repositories 128. For example, interface design data objects, input data objects, training data, graph neural networks 124, predicted classifications, updates to graphical user interfaces, identified components, preapproved components, and/or the like may be stored within, retrieved from, and/or otherwise made available via the component prediction repositories 128.

### Example Apparatuses of the Disclosure

Having discussed example systems in accordance with the present disclosure, example apparatuses in accordance with the present disclosure will now be described.

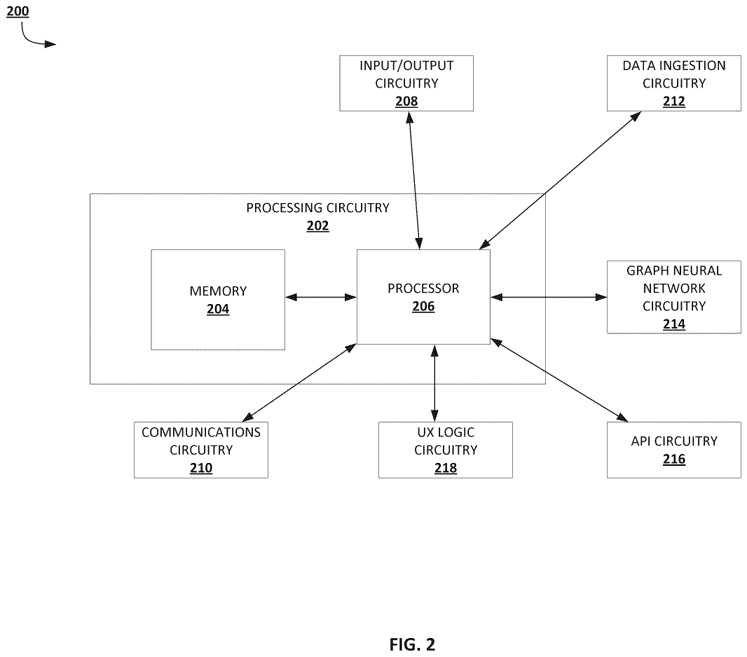

FIG. 2 illustrates a block diagram of an apparatus 200 in accordance with some example embodiments. For example, in some embodiments, the UX logic engine 122, graph neural networks 124, data ingestion engine 126, and/or component prediction repositories 128 may be embodied by one or more apparatuses 200. In this regard, in some embodiments, the component prediction system 120 or one or more portions (e.g., one or more individual components) thereof, if embodied in a particular embodiment, may be embodied by one or more apparatuses 200. A user device 102 may be similarly structured.

In some embodiments, the apparatus 200 may include a processing circuity 202 as shown in FIG. 2. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the functionality of the component prediction system 120 or any subset thereof may be performed by a single apparatus 200 or multiple apparatuses 200. In some embodiments, the apparatus 200 may comprise one or a plurality of physical devices, including distributed, cloud-based, and/or local devices.

Although some components are described with respect to functional limitations, it should be understood that the particular implementations necessarily include the use of particular computing hardware, such as the hardware shown in FIG. 2. It should also be understood that certain of the components described herein may include similar or common hardware. For example, two sets of circuitries for example, may both leverage use of the same processor(s), network interface(s), storage medium(s), and/or the like, to perform their associated functions, such that duplicate hardware is not required for each set of circuitry and a single physical circuitry may be used to perform the functions of multiple circuitries described herein. The use of the term “circuitry” as used herein with respect to components of the apparatuses described herein should therefore be understood to include particular hardware configured to perform the functions associated with the particular circuitry as described herein.

In some embodiments, “circuitry” may include processing circuitry, storage media, network interfaces, input/output devices, and/or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, and/or the like.

The apparatus 200 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, and/or other processing and management services according to one or more example embodiments. In some embodiments, the apparatus 200 or a portion(s) or component(s) thereof, such as the processing circuitry 202, may be embodied as or comprise a chip or chip set. In other words, apparatus 200 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (and/or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) and/or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry-in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, and/or one or more remote or “cloud” processor(s) external to the apparatus 200.

In some example embodiments, the memory 204 may include one or more non-transitory memory devices such as, for example, volatile and/or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions and/or the like for enabling the apparatus 200 to carry out various functions in accordance with one or more example embodiments. For example, the memory 204 may be configured to buffer input data for processing by the processor 206. Additionally or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208 and/or communications circuitry 210, via a bus(es) for passing information among components of the apparatus 200.

The input/output circuitry 208 may provide output to the user or an intermediary device and, in some embodiments, may receive one or more indication(s) of user input. In some embodiments, the input/output circuitry 208 is in communication with processor 206 to provide such functionality. The input/output circuitry 208 may include one or more user interface(s) and/or include a display that may comprise the user interface(s) rendered as a web user interface, an application interface, and/or the like, to the display of a user device, a backend system, or the like. The input/output circuitry 208 may be in communication with the processing circuitry 202 to receive an indication of a user input at the user interface and/or to provide an audible, visual, mechanical, or other output to the user. As such, the input/output circuitry 208 may include, for example, a keyboard, a mouse, a joystick, a display, a touch screen display, a microphone, a speaker, and/or other input/output mechanisms. As such, the input/output circuitry 208 may, in some example embodiments, provide means for a user to access and interact with the apparatus 200. The processor 206 and/or input/output circuitry 208 comprising or otherwise interacting with the processor 206 may be configured to control one or more functions of one or more user interface elements through computer program instructions (e.g., software and/or firmware) stored on a memory accessible to the processor 206 (e.g., stored on memory 204, and/or the like).

The communications circuitry 210 may include one or more interface mechanisms for enabling communication with other devices and/or networks. In some cases, the communications circuitry 210 may be any means such as a device or circuitry embodied in either hardware, or a combination of hardware and software that is configured to receive and/or transmit data from/to a network and/or any other device or module in communication with the processing circuitry 202. The communications circuitry 210 may, for example, include an antenna (or multiple antennas) and supporting hardware and/or software for enabling communications with a wireless communication network (e.g., a wireless local area network, cellular network, global positioning system network, and/or the like) and/or a communication modem or other hardware/software for supporting communication via cable, digital subscriber line (DSL), universal serial bus (USB), Ethernet or other methods.

In some embodiments, the apparatus 200 may include a data ingestion circuitry 212 which may include hardware components, software components, and/or a combination thereof configured to, with the processing circuitry 202, input/output circuitry 208 and/or communications circuitry 210, perform one or more functions associated with the data ingestion engine 126 (as described above with reference to FIG. 1). For example, the data ingestion circuitry 212 may access, facilitate access, receive, process, manipulate, provide, or otherwise use, or make available for use, data (e.g., interface design data objects, input data objects, and/or other data) used by one or more other components of the apparatus 200 through, for example, the use of hardware, software, applications, or APIs executed using a processor, such as the processor 206. In some embodiments, the data ingestion circuitry 212 may interact with the memory 204, which may store the aforementioned data. It should also be appreciated that, in some embodiments, the data ingestion circuitry 212 may include a separate processor, specially configured field programmable gate array (FPGA), or application specific interface circuit (ASIC) to provide or otherwise facilitate access to such data used by one or more other components of the apparatus 200. The data ingestion circuitry 212 may also provide for communication with other components of the apparatus, system and/or external systems via a network interface provided by the communications circuitry 210.

In some embodiments, the apparatus 200 may include a graph neural network circuitry 214 which may include hardware components, software components, and/or a combination thereof configured to, with the processing circuitry 202, input/output circuitry 208 and/or communications circuitry 210, perform one or more functions associated with the component prediction system 120 (as described above with reference to FIG. 1). For example, the graph neural network circuitry 214 may access, facilitate access, receive, process, manipulate, provide, or otherwise use, or make available for use, certain data (e.g., input data objects, predicted classifications, training data, and/or other data) used by one or more other components of the apparatus 200 through, for example, the use of hardware, software, applications, or APIs executed using a processor, such as the processor 206. In some embodiments, the graph neural network circuitry 214 may interact with the memory 204, which may store the aforementioned data. It should also be appreciated that, in some embodiments, the graph neural network circuitry 214 may include a separate processor, specially configured field programmable gate array (FPGA), or application specific interface circuit (ASIC) to receive such data utilized by the graph neural network circuitry 214. The graph neural network circuitry 214 may also provide for communication with other components of the apparatus, system and/or external systems via a network interface provided by the communications circuitry 210.

In some embodiments, the apparatus 200 may include an API circuitry 216 which may include hardware components, software components, and/or a combination thereof configured to, with the processing circuitry 202, input/output circuitry 208 and/or communications circuitry 210, perform one or more functions associated with the component prediction system 120 (as described above with reference to FIG. 1). For example, the API circuitry 216 may access, facilitate access, receive process, manipulate, provide, or otherwise use, or make available for use, certain data e.g., interface design data objects, input data objects, predicted classifications, updates to graphical user interfaces, and/or other data) used by one or more other components of the apparatus 200 through, for example, the use of hardware, software, applications, or APIs executed using a processor, such as the processor 206. In some embodiments, the API circuitry 216 may interact with the memory 204, which may store the aforementioned data. It should also be appreciated that, in some embodiments, the API circuitry 216 may include a separate processor, specially configured field programmable gate array (FPGA), or application specific interface circuit (ASIC) to manage access and use of such data. The API circuitry 216 may also provide for communication with other components of the apparatus, system and/or external systems via a network interface provided by the communications circuitry 210.

In some embodiments, the apparatus 200 may include a UX logic circuitry 218 which may include hardware components, software components, and/or a combination thereof configured to, with the processing circuitry 202, input/output circuitry 208 and/or communications circuitry 210, perform one or more functions associated with the component prediction system 120 (as described above with reference to FIG. 1). For example, the UX logic circuitry 218 may access, facilitate access, receive, process, manipulate, provide, or otherwise use, or make available for use, certain data (e.g., predicted classifications, updates to graphical user interfaces, and/or other data) used by one or more other components of the apparatus 200 through, for example, the use of hardware, software, applications, or APIs executed using a processor, such as the processor 206. In some embodiments, the UX logic circuitry 218 may interact with the memory 204, which may store the aforementioned data. It should also be appreciated that, in some embodiments, the UX logic circuitry 218 may include a separate processor, specially configured field programmable gate array (FPGA), or application specific interface circuit (ASIC) to receive such data utilized by the UX logic circuitry 218. The UX logic circuitry 218 may also provide for communication with other components of the apparatus, system and/or external systems via a network interface provided by the communications circuitry 210.

In this regard, FIG. 1 shows an example system environment 100 within which at least some embodiments of the present disclosure, including apparatus(es) 200, may operate. The depictions of the example system environment 100 and apparatus 200 are not intended to limit or otherwise confine the embodiments described and contemplated herein to any particular configuration of elements or systems, nor are they intended to exclude any alternative configurations or systems for the set of configurations and systems that can be used in connection with embodiments of the present disclosure. Rather, FIGS. 1-2 and the system environment 100 and apparatus(es) 200 disclosed therein are merely presented to provide an example basis and context for the facilitation of some of the features, aspects, and uses of the methods, apparatuses, computer readable media, and computer program products disclosed and contemplated herein. As noted above, in some embodiments, component prediction system 120; the user device(s) 102; and/or the software program system 130 may be embodied by one or more apparatuses 200 shown in FIG. 2 or portions thereof relevant to the functions of the respective devices.

### Example Data Flows and Data Structures of the Disclosure

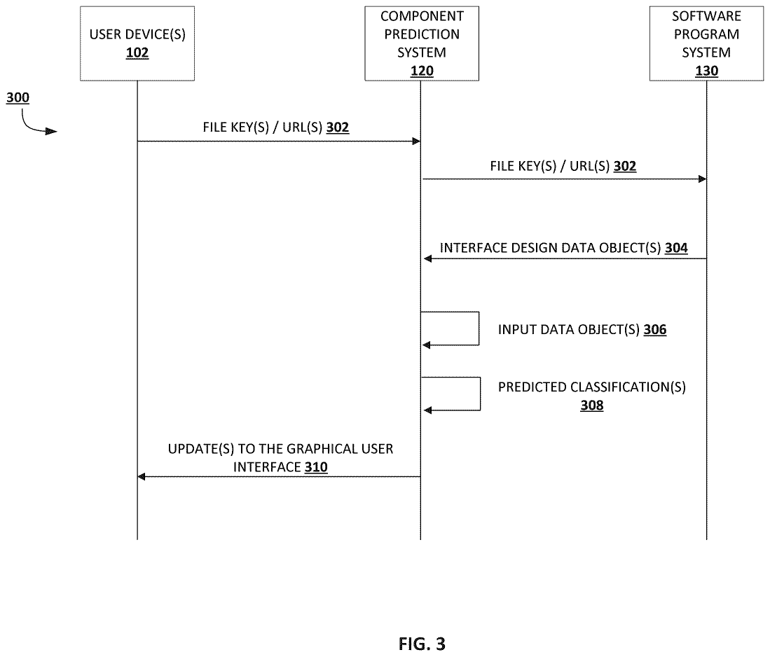

FIG. 3 is an example data flow 300 presented in accordance with one or more embodiments of the present disclosure. In some example embodiments, the data structures and processes shown and described with respect to the data flow diagram of FIG. 3 may be generated, performed, and/or otherwise facilitated by the various systems and apparatuses shown and described with respect to FIGS. 1-2.

As shown, the user device 102 or other apparatus may provide an input, such as one or more file keys or URLs 302 to the component prediction system 120. In various examples, a file key or URL may be associated with a respective interface design data object. The component prediction system 120 may provide the one or more file keys or URLs 302 to the software program system 130 (e.g., FIGMA or the like) to receive the one or more interface design data objects 304 (e.g., a . JSON file or the like). In some alternative embodiments, the user device 102 may provide the one or more file keys or URLs 302 to the software program system 130. In some examples, a file key or URL may be used as an input parameter for a REST API call to retrieve an exported interface design data object. For example, the component prediction system 120 may query the API 134 of the software program system 130 using the one or more file keys or URLs 302 to receive the one or more interface design data objects 304. In some instances, any other methodology may be used to generate and/or gather a tree like representation of the interface (e.g., any representation capable of being applied to the graph neural network(s) as described herein). In various examples, an interface design data object may include a text-based representation of each of a graphical user interface. In some examples, the text-based representation of at least a portion of a plurality of nodes includes data indicating at least one parent or child node. For example, the one or more interface design data objects 304 may provide all the information on the attributes (e.g., attributes of frames/layers and/or components) and the structure (e.g., parent-child relationships between frames and/or layers) of a graphical user interface. In some examples, the component prediction system 120 may receive the one or more interface design data objects 304 using the data ingestion engine 126.

In some embodiments, the component prediction system 120 may generate one or more input data objects at operation 306. For example, the component prediction system 120 may generate the one or more input data objects at operation 306 based on the one or more interface design data objects 304. Creating the one or more input data objects from the interface design data objects may include converting the text-based data of the input data objects into a computer-readable form for input into the various predictive modeling processes described herein. In some embodiments, the conversion into the input data object may include extracting parent/child relations from the interface design data object (e.g., by assembling a hierarchical tree of relationships between the frames or layers of the interface). These parent/child relations may be used to define an adjacency matrix, while each node (e.g., each frame or layer of the interface) properties are used to generate an input node feature vector, that for all the nodes forms the node feature matrix. In some embodiments, the adjacency matrix and node feature matrix may then used as an input of the graph neural network that provides as output the targeted node classification. In certain examples, an input data object may represent the plurality of frames and/or layers as a plurality of nodes related to each other based on the data indicating the at least one parent or child node. For example, the parent-child relationships between nodes and attributes of the graphical user interface may be used to define and/or generate the input data objects or one or more portions thereof at operation 306. In some examples, the component prediction system 120 may generate the one or more input data objects at operation 306 using the data ingestion engine 126.

In some embodiments, the component prediction system 120 may generate one or more predicted classifications at operation 308. For example, the component prediction system 120 may generate the one or more predicted classifications at operation 308 based on the one or more input data objects generated at operation 306. In various examples, a predicted classification may be associated with at least one of the plurality of nodes. In some examples, the component prediction system may generate the one or more predicted classifications at operation 308 using the one or more graph neural networks 124 (e.g., by applying the one or more input data objects to the one or more graph neural networks 124). In some embodiments, multiple input data objects may be created for different portions of a graphical user interface such that the process may be repeated for different segments of the interface separately (e.g., two different regions of the graphical user interface may have their own input data objects and may be separately classified).

In some embodiments, the component prediction system 120 may generate and provide one or more updates to the graphical user interface 310 to the user device 102. For example, the component prediction system 120 may generate and provide the one or more updates to the graphical user interface 310 to the user device 102 using the UX logic engine 122. An update to the graphical user interface 310 may, for example, indicate via the user device 102 whether the graphical user interface adheres to one or more compliance parameters and/or may modify the interface to correct the non-compliance (e.g., to resolve any potential risks or issues with the interface). In some examples, an update to the graphical user interface 310 may identify one or more components identified within the interface design data object 304 that do not adhere to the one or more compliance parameters and/or cause the user device 102 to provide an indication to a user (e.g., a UX developer reviewing the graphical user interface). In such embodiments, the update may take the form of emphasizing, highlighting, shading, circling, or otherwise modifying the user interface to non-textually indicate the non-compliant components. In some embodiments, the update may comprise an overlay, a textual display, or other additional interface element added to indicate the noncompliance.

Additionally or alternatively, in some examples, an update to the graphical user interface 310 may directly and/or automatically update the graphical user interface. For example, an update to the graphical user interface 310 may automatically replace one or more components identified within the interface design data object 304 that do not adhere to the one or more compliance parameters with one or more pre-approved components that are pre-approved to adhere to the one or more compliance parameters and are identified as likely to be suitable replacement components (e.g., replacing a particular button that fails to adhere to compliance parameters with a similar and pre-approved component that does adhere to compliance parameters). In such embodiments, the classification process 308 may identify a predicted pre-approved component corresponding to the noncompliant component (e.g., a pre-approved component with the highest probability of matching the noncompliant component). In some embodiments, the user may select (e.g., via a menu on the interface) a pre-approved component from a list of pre-approved components to replace the noncompliant component.

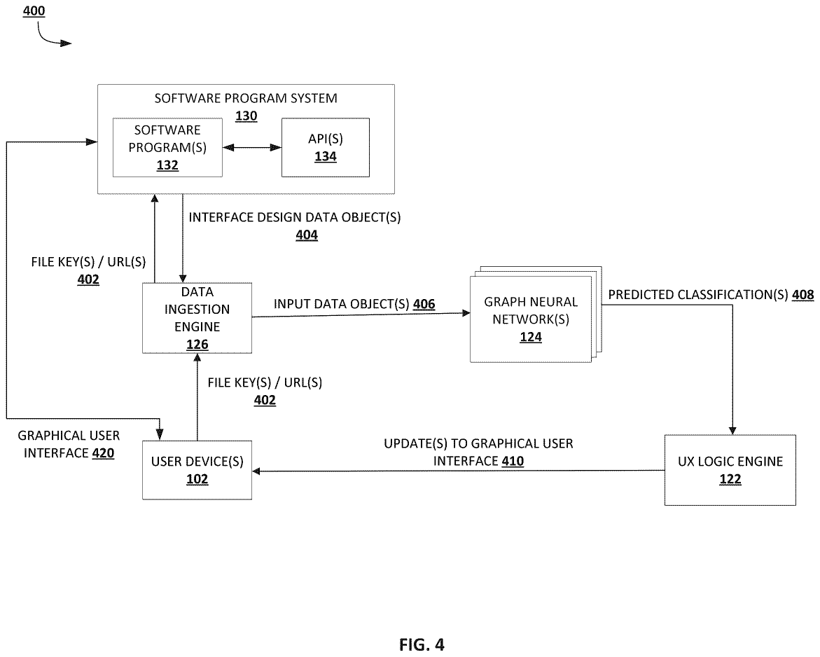

FIG. 4 is an example data flow diagram 400 presented in accordance with one or more embodiments of the present disclosure. In some example embodiments, the data structures and processes shown and described with respect to the data flow diagram of FIG. 4 may be generated, performed, and/or otherwise facilitated by the various systems and apparatuses shown and described with respect to FIGS. 1-2. The process illustrated in FIG. 4 may correspond to the process shown and described with respect to FIG. 3.

In the depicted embodiment, the user device 102 may be used to generate the graphical user interface 420 using the software program system 130. For example, the user device 102 may access a software program 132 (e.g., FIGMA or the like) to create and design the graphical user interface 420. The graphical user interface 420 may be represented by the interface design data object 404. The component prediction system 120 (e.g., the data ingestion engine 126, graph neural networks 124, and/or UX logic engine 122) may be used to determine whether the graphical user interface 420 adheres to one or more compliance parameters via one or more updates to the graphical user interface 410. For example, the user device 102 may use the component prediction system 120 to generate the updates to the graphical user interface 410 based on the interface design data object 404 and the one or more compliance parameters.

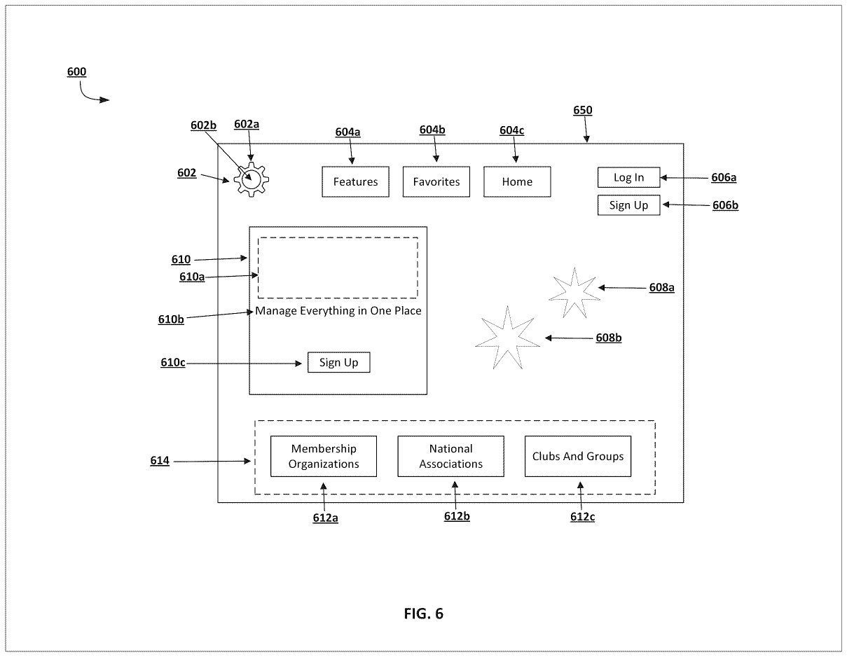

Turning to FIG. 6, an example graphical user interface 600 is presented in accordance with one or more embodiments of the present disclosure. In some example embodiments, the graphical user interface 600 shown and described with respect to FIG. 6 may be generated, transmitted, received, and/or otherwise interacted with by the various systems and apparatuses shown and described with respect to FIGS. 1-2.

In some embodiments, the graphical user interface 600 may be generated using a software program system 130. For example, the user device 102 may use a software program 132 to generate the graphical user interface 600 and a corresponding API 134 (e.g., a REST API associated with the software program 132) may be used to support access to and interactions with the graphical user interface 600, for example, by providing an interface design data object representative of the graphical user interface 600.

The graphical user interface 600 is made up of a plurality of frames and/or layers representing one or more components. For example, the graphical user interface 600 includes the settings button 602, features button 604a, favorites button 604b, home button 604c, log in button 606a, sign up button 606b, icons 608a-b, advertisement 610, and the footer 614, each of which may include one or more components comprising one or more frames and/or layers. For example, the settings button 602 is a component and includes the gear 602a and circle 602b. As another example, the footer 614 is a component and includes the membership organizations button 612a, national associations button 612b, and clubs and groups button 612c. Each of the buttons 612a-c may also include one or more frames and/or layers.

The graphical user interface 600 may be associated with a structure (e.g., nested frames or layers) such that each node of the graphical user interface 600 may have a relationship with one or more other nodes. For example, each node of the graphical user interface 600 may be associated with zero (e.g., a leaf node), one, or more child nodes and zero (e.g., a root node) or one parent node. The software program (e.g., software program 132 shown in FIG. 1) used to create and manage the graphical user interface 600 may be configured to maintain and output the interface design data object (e.g., via APIs 134 shown in FIG. 1) representing the aforementioned nodes and the components represented thereby.

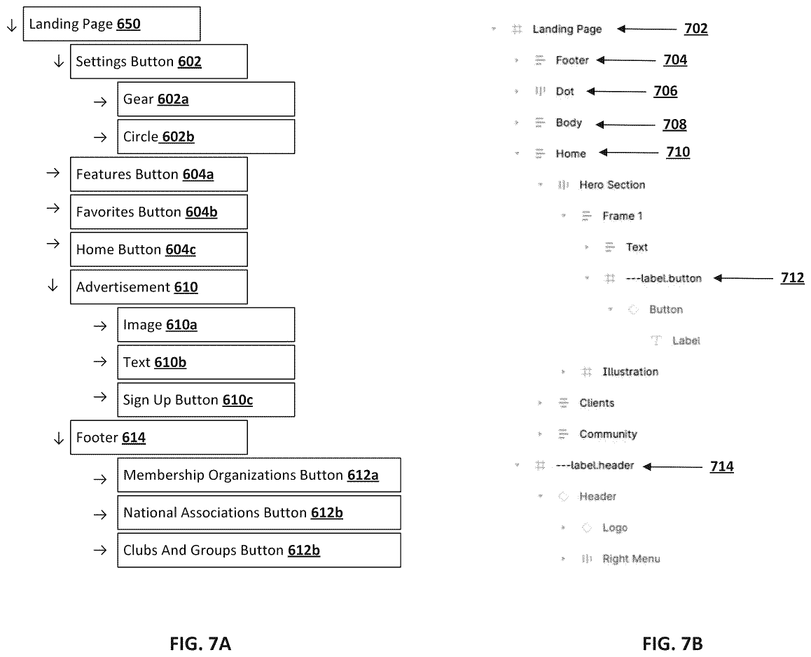

FIG. 7A illustrates an example representation of the structure associated with the graphical user interface 600 in accordance with at least some embodiments of the present disclosure. For example, the representation shown within FIG. 7A may be generated by and/or used within a software program 132 used to generate the graphical user interface 600. The visualization depicted in FIG. 7A may represent a graphical arrangement of the hierarchy of the nodes within the graphical user interface.

The landing page 650, for example, may be a frame or layer that is a parent to the settings button 602, features button 604a, favorites button 604b, home button 604c, advertisement 610, and footer 614. Although not shown in FIG. 7A for simplicity, the landing page 650 may also be a parent to the log in button 606a, sign up button 606b, and icons 608a-b. The settings button 602 may include a frame or layer that is a parent to the gear 602a and circle 602b (which also may be one or more frames and/or layers) that together make up the component that is the settings button 602. Similarly, the advertisement 610 may include a frame or layer that is a parent to the image 610a, text 610b, and the sign up button 610c, and the footer 614 may include a frame or layer that is a parent to the membership organizations button 612a, the national associations button 612b, and the clubs and groups button 612c. Accordingly, some components of the graphical user interface 600 may be nested within other components. For example, the advertisement 610 includes the sign up button 610c and the footer 614 includes the buttons 612a-c, each of which may include additional frames, layers, and/or components. While specific components and frames are illustrated for example purposes, any graphical user interface comprising any arrangement of components and/or the nodes representing such components may be represented via a similar structural diagram.

In an example, the graphical user interface 600 of FIG. 6 may be required to adhere to one or more compliance parameters. For example, the various buttons of the graphical user interface 600 may be required to adhere to parameters defining attributes and/or the like, such as a particular color, shape, font, size, position, etc. In an example, the buttons 604a-c may be required to adhere to one or more compliance parameters defining one common style since these buttons serve as the navigation buttons at the top of the graphical user interface 600 while the buttons 612a-c may be required to adhere to one or more compliance parameters defining a different common style since these buttons are included within the footer 614. Additionally, for example, the buttons 606b and 610c may be required to be identical (i.e., adhere to the same compliance parameters) since these are both sign up buttons.

Returning to FIG. 4, the one or more file keys or URLs 402 may be provided to the data ingestion engine 126. The one or more file keys or URLs 402 may identify the interface design data object 404 (or the graphical user interface 420) and may be used to transmit and/or receive the interface design data object 404. In some examples, a file key or URL 402 may be generated by the user device 102 or the software program system 130 (e.g., via a software program 132 or API 134). In some examples, the file key or URL 402 may be received by the data ingestion engine 126 from the user device 102 or the software program system 130 (e.g., with a request to review the graphical user interface 420). In some examples, the data ingestion engine 126 may request the file key or URL 402 from the user device 102 or the software program system 130 (e.g., in response to a request to review the graphical user interface 420).

The data ingestion engine 126 may provide the one or more file keys or URLs 402 to the software program system 130 to receive the one or more interface design data objects 404. For example, the data ingestion engine 126 may query the API 134 of the software program system 130 using the one or more file keys or URLs 402 to receive the one or more interface design data objects 404.

Using the one or more interface design data objects 404, the data ingestion engine 126 may generate the one or more input data objects 406 and provide the one or more input data objects 406 to one or more of the one or more graph neural networks 124. A graph neural network 124 may use an input data object 406 to generate one or more predicted classifications 408, and the one or more predicted classifications 408 may be provided to the UX logic engine 122. The UX logic engine 122 may generate one or more updates to the graphical user interface 410 and provide the one or more updates to the graphical user interface 410 to the user device 102. In some embodiments, the user device 102 may display the one or more updates to the graphical user interface 410 to a user via a display of the user device 102. In some examples, the one or more updates to the graphical user interface 410 may include one or more notifications, components, automated actions, and/or the like.

Referring to the example graphical user interface 600 of FIG. 6, similar to the data flow described above with respect to FIG. 4, an interface design data object representative of the graphical user interface 600 may be provided to the component prediction system 120 to, for example, revise the graphical user interface 600 for compliance with one or more compliance parameters. Consider, for example, that the sign up button 606b was sourced from a library of preapproved components and therefore adheres to the one or more compliance parameters and that the sign up button 610c for some reason was custom built and does not adhere to the one or more compliance parameters (e.g., the font and color used for the button are noncompliant).

Continuing the above example, an interface design data object representative of the graphical user interface 600 may be received by the component prediction system 120 and used to generate an input data object. The input data object may be applied to a graph neural network 124 which may be configured to identify the sign up button 610c and classify the sign up button 610c as failing to adhere to the one or more compliance parameters. As noted above, the graph neural network may be configured to detect compliance with parameters, detect the matching (or lack thereof) between a component of the interface and a pre-approved, or other similar compliance analysis based on the trained graph neural network. For example, the graph neural network 124 may generate a predicted classification that identifies the sign up button 610c as an unknown component, a known but non-compliant component, a non-preapproved component, a component that is a modified preapproved component, and/or the like.

Continuing the above example, the UX logic engine 122 may receive the predicted classification and generate an update to the graphical user interface for the graphical user interface 600. For example, the update to the graphical user interface may identify (e.g., via a notification to be displayed on a screen of user device 102, by highlighting the sign up button 610c for review on a screen within a software program 132, etc.) the sign up button 610c as an unknown component, a known but non-compliant component, a non-preapproved component, a component that is a modified preapproved component, and/or the like. Additionally or alternatively, in some examples, the update to the graphical user interface may suggest (e.g., via a notification to be displayed on a screen of user device 102, as an interactable prompt within a software program 132, etc.) a preapproved component to replace the sign up button 610c such as, for example, with the preapproved sign up button 606b which is determined to be similar to the sign up button 610c (e.g., as determined using embeddings, similarity scores, confidence thresholds, etc.); may automatically replace (e.g., as an automatic action within a software program 132) the sign up button 610c with a preapproved component such as, for example, the preapproved sign up button 606b; may indicate (e.g., via a notification to be displayed on a screen of user device 102) one or more reasons or attributes for review which are determined non-compliant with the one or more compliance parameters (e.g., the font and color used for the button are noncompliant); and/or various combinations of the foregoing.

The analysis and update processes described herein may be part of a software development lifecycle flow, whereby upon completion of a draft graphical user interface or upon the occurrence of one or more milestones during creation of a graphical user interface, the component prediction system may be prompted to analyze the components of the draft graphical user interface for compliance. In some embodiments, the review may occur in real time as components are created and/or completed. The review and subsequent updating may occur prior to public release of the graphical user interface. In some embodiments, the analysis and/or update process may be synchronous and initiated by the user once he or she is done with a component or group of components. In some instances, analysis and/or update process may be asynchronous (e.g., continuously checking or checking at predetermined intervals in addition to or instead of checking upon completion of a milestone or other input by a user) and independently able to trigger (e.g., generating messages and/or taking actions, such as suggesting a new component or replacing the detected component with a pre-approved component) during the design process as soon as one or more components are detected.

In some embodiments, the “update” process may occur during software development to expedite the development process. For example, a user may draft a mockup of a component that they would like inserted into the interface, and run the mockup through the component prediction system. The component prediction system may then suggest a pre-approved component most closely resembling the mockup and/or may automatically replace the mockup with the preapproved component predicted to be intended by the user. This process may save the UX designer time by not requiring extensive customization or a detailed knowledge of the pre-approved component library to quickly build compliant user interfaces.

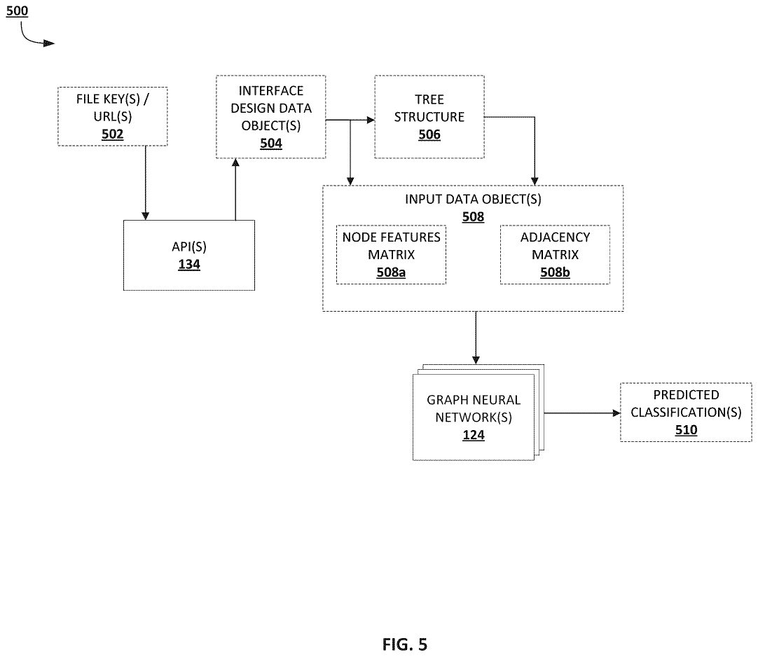

FIG. 5 is an example data flow 500 presented in accordance with one or more embodiments of the present disclosure. In some example embodiments, the data structures and processes shown and described with respect to the data flow diagram of FIG. 5 may be generated, performed, and/or otherwise facilitated by the various systems and apparatuses shown and described with respect to FIGS. 1-2.

As described with respect to FIGS. 1, 3, and 4, one or more file keys or URLs 502 associated with one or more interface design data objects 504 may be provided to the API 134, for example, as or included within an API request (e.g., via the data ingestion engine 126). In response, the API 134 may provide the one or more interface design data objects 504 (e.g., to the data ingestion engine 126).

In some embodiments, the interface design data object 504 may be associated with and/or represented as a tree structure 506 (e.g., the text-based interface design data object may comprise hierarchical data, such as parent/child relationships, representable as a tree structure). For example, the interface design data object 504 may include data representative of a plurality of nodes and one or more relationships between two or more of the plurality of nodes (e.g., the nodes, node attributes, and relationships between nodes as mentioned with respect to FIG. 6). Accordingly, in some examples, such data may be represented as a tree structure 506, graph, and/or the like, including a plurality of nodes connected by one or more edges, where the plurality of nodes represent the plurality of frames and/or layers and the one or more edges represent the one or more relationships. The tree structure 506 may be useful for visualizing an interface design data object 504 and/or generating an input data object 508. In some embodiments, an actual tree structure need not be separately created. For example, the input data object (e.g., the adjacency and node features matrices) may be created directly from the interface design data object.

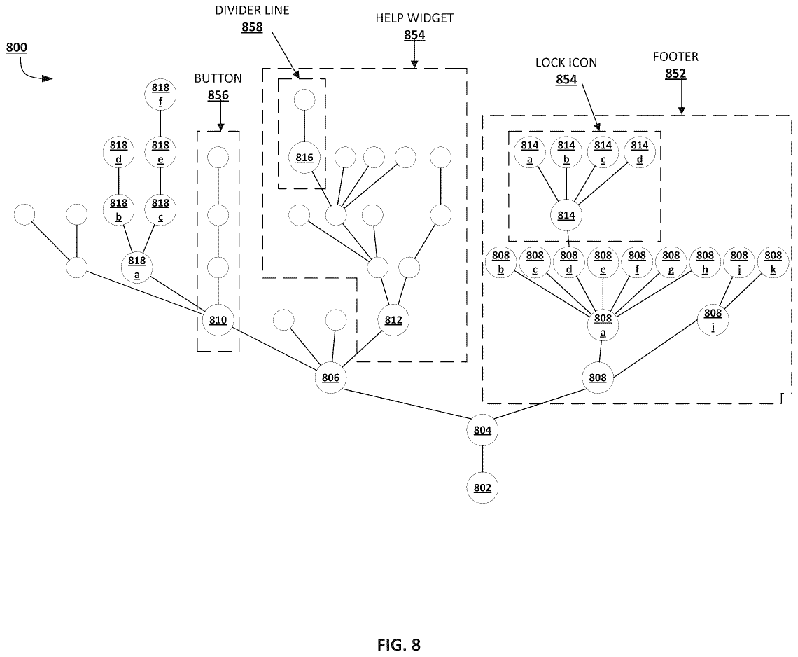

Turning to FIG. 8, an example of a tree structure 800 is presented in accordance with one or more embodiments of the present disclosure. As shown, the nodes of the tree structure 800 represent frames and/or layers of a graphical user interface (e.g., the graphical user interface 600). The nodes are connected by edges representative of relationships between corresponding nodes. For example, the node 802 corresponds to a parent node for the graphical user interface (e.g., similar to the landing page 650 for the graphical user interface 600); the node 804 corresponds to a child node of the node 802; the nodes 806 and 808 correspond to child node s of node 804; etc. For example, the lines connecting the nodes in FIG. 8 may graphically indicate the parent/child relationships extracted from the interface design data object. In some embodiments, each node may have only a single immediate parent to which it is directly connected. In various embodiments, a component of a graphical user interface may include one or more of the plurality of frames and/or layers represented by the nodes and the one or more of the plurality of nodes may include at least one root node defining a start of the component and at least one leaf node defining a lowest layer or frame of the component. For example, the node 808 corresponds to a node that is also a root node of the footer component 852. The footer component 852 includes the lock icon component 854 which also includes the several nodes as shown by the several nodes 814 and 814a-d within the lock icon component 854. Similarly, the nodes 814, 810, 812, and 816 each correspond to a root node. In this manner, the nodes 808, 810, 812, 814, and 816 may also be referred to as root nodes.

Returning to FIG. 5, the one or more interface design data objects 504 and/or one or more respective tree structures 506 may be used to generate one or more input data objects 508. For example, the data ingestion engine 126 may generate the one or more input data objects 508 based on the one or more interface design data objects 504 and/or the tree structure 506. The input data object 508 may include the node features matrix 508a and the adjacency matrix 508b. For example, the data ingestion engine 126 may be configured to generate the node features matrix 508a and the adjacency matrix 508b based on the interface design data object 504. In some embodiments, an edge weighting and/or feature matrix may be used (e.g., in addition to the adjacency matrix). Similar to the tree structure 506, the input data objects 508 may be alternative representations of the graphical user interface based on the interface design data objects 504. In various examples, the input data objects 508 may include additional and/or alternative data structures in addition to and/or in place of the node features matrix 508a and the adjacency matrix 508b. In any case, the input data objects 508 are configured for input to the one or more graph neural networks 124.

In an example, the node features matrix 508a may include one or more vectorized representations of the plurality of nodes including features associated with the plurality of nodes. In this manner, the node features matrix 508a may include representations of the plurality of nodes having attributes within the graphical user interface as vectorized representations of nodes having features.

For example, consider a frame or layer represented by node 808 of FIG. 8. The frame or layer may include one or more attributes (e.g., colors, positions, fonts, boundaries, etc.). In this example, each attribute may be represented by a column (i.e., feature) of the node features matrix 508a. Further, in this example, a row of the node features matrix 508a representative of the node 808 may be configured such that the row includes a vector of feature values corresponding to each attribute of the frame or layer.

Said differently, in another example, assume the footer 614 of FIG. 6 is represented by the footer component 852 of FIG. 8 and that the node 808 is representative of a frame or layer within the footer 614. In this example, the frame or layer may be associated with a plurality of attributes such as the position, color, boundaries, etc. The node 808 representative of the frame or layer may be included within the node features matrix 508a as a vector of feature values corresponding to each attribute such as the position, color, boundaries, etc., of the frame or layer.

In an example, the adjacency matrix 508b may include one or more vectorized representations of the plurality of nodes related to each other. In this manner, the adjacency matrix 508b may include representations of the plurality of relationships between nodes within the graphical user interface as vectorized representations.

For example, consider a parent node and a child node of the parent node, such as the respective nodes 802 and 804 of FIG. 8. In this example, each node may be represented by a row and a column of the adjacency matrix 508b such that the intersection of the row for node 802 and the column for node 804 includes a value indicative of the relationship between the node 802 and the node 804. For example, the value may be 1 and indicate that node 804 is a child of the node 802. In another example, the value may be 0 and indicate that the node 804 is not a parent of the node 802. Other values and indications may be used in other examples.

The input data object 508 may be configured to be input to the one or more graph neural networks 124. The graph neural networks 124 may generate the one or more predicted classifications 510 based on the input data objects 508. For example, the predicted classification output may include, for each node, a label (e.g., a name or key) of the detected component or no label if none is detected or the node is not the root node of a detected component.

In some examples, the predicted classifications 510 may be associated with at least one of the plurality of nodes. For example, the predicted classifications 510 may be used to identify, via component classification, components of the graphical user interface based on the input data objects 508. In some examples, the predicted classifications 510 may include node-level classifications. In an example, such a node level classification may indicate a component classification for a node, a root classification for a node, and/or the like.

For example, a predicted classification may perform root classification to identify node 808 of FIG. 8 as a root node. Additionally or alternatively, a predicted classification may identify nodes 808a-k as non-root nodes. Additionally or alternatively, a predicted classification may identify one or more of the nodes 808 and/or 808a-k as included within the footer component 852 via a component classification.

In some examples, the predicted classifications 510 may include graph-level classifications. In an example, such graph-level classifications may include at least two nodes and indicate a component classification for the at least two nodes. In some embodiments, the graph neural networks 124 and associated processes may first identify the root nodes of each of the components of the graphical user interface (e.g., root classification) and subsequently classify each of the identified components (e.g., component classification).

For example, a predicted classification may include component classifications for each subtree structure of a tree structure. In such an example, each subtree structure may serve as an input to a graph neural network 124, either collectively or individually. For instance, one input associated with the tree structure 800 of FIG. 8 may include the subtree structure including the nodes 814 and 814a-d; another input may include the subtree structure including the nodes 814, 814a-d, and 808a-h; another input may include the subtree structure including the nodes 808i-k; and yet another input may include the subtree structure including the nodes 808, 808a-k, 814, and 814a-d. In such an example, a component classification may be assigned to each subtree structure which may, for example, determine that the subtree structure including the nodes 814 and 814a-d is most likely the lock icon component 854 (e.g., as determined using embeddings, similarity scores, confidence thresholds, etc.); the subtree structure including the nodes 808 and 808a-k is most likely the footer component 852; and the subtree structure including nodes 818a-f is not likely to be any known component.

Accordingly, in various embodiments, a graph neural network 124 may be trained for one or more of the various prediction-based tasks associated with the predicted classifications. For example, a graph neural network 124 may be trained to perform node-level classification and generate a root classification and/or a component classification. Additionally or alternatively, a graph neural network 124 may be trained to perform graph-level classification and generate a component classification for a subtree structure. In various examples, one or more graph neural networks 124 trained for various prediction-based tasks may be used. Additionally or alternatively, in some examples, a graph neural network 124 may be modified to perform various prediction-based tasks by, for example, modifying the final dense layers of the graph neural network 124. Additionally or alternatively, in some examples, a graph neural network 124 may be trained via multi-task learning and perform multiple prediction-based tasks such as node-level classification and graph-level classification.

In various embodiment, a graph neural network 124 may be trained using training data configured for a respective prediction-based task. In an example, a graph neural network 124 may be trained (e.g., by the component prediction system 120) using training data including at least text-based representations of a plurality of labeled nodes indicating a component classification for each labeled node. For example, such training data may include a set of graphical user interfaces and/or components (e.g., represented by interface design data objects, input data objects, or the like) where each component is labeled.

In an example, labels may be added to the components using a software program 132. For example, if a particular defined naming template within a software program 132 is “---label.<component_name>”, a labelling procedure may include the addition of a new parent node added to the root node of the component where the new parent node includes the name “---label.button” to label the component as a button. Such a technique may provide for labelling within a software program 132 without the need for an external labelling tool. Such a technique may also provide for efficient and easy handling by the data ingestion engine 126 after receiving a corresponding interface design data object via the API 134. Using the training data including the labeled components, (e.g., via the technique described above or any other applicable technique), the training data may include a tree structure with an additional feature for each node indicating its label. In some examples, a label may be “none”, one of the possible components to be identified, and/or the like. Additionally or alternatively, in some examples, the labels may include root node classifications. In some embodiments, the training algorithm, prior to training the graph neural network, may embed or remove the labeled nodes (e.g., the new parent nodes described above) to retain the label data while restoring the original structure of the components. For example, in some embodiments, the API 134 may be loaded with the initial training data (e.g., including the new labeled parent nodes), the parent nodes that include the labels may be identified, and the labels may be applied as properties to the child node beneath the new parent (e.g., the former main node of the component), after which the new parent nodes with the placeholder label may be deleted and training may be performed. In this manner, a developer or other user can quickly generate labels (e.g., by creating the new parent nodes), and the component prediction system 120 can quickly embed those labels and train the graph neural network using the labeled training data.

FIG. 7B illustrates an example of such a labeling technique that may be applied in accordance with one or more embodiments of the present disclosure. As shown, the landing page 702 may be a frame or layer that includes the footer component 704, the dot layer 706, the body component 708, and home component 710. In this example, the labels 712 and 714 (respectively designated as “---label.button” and “---label.header”) may be added to identify the respective components. A graph neural network 124 may, for example, be trained on such training data (e.g., using a backpropagation mechanism and a cross-entropy loss function) to predict the correct root classifications, component classifications to each node, etc. as indicated by the labels.

In an example, a graph neural network 124 may be trained using training data including at least text-based representations of a plurality of nodes that make up preapproved components that are labeled with corresponding component classifications. In such an example, the graph neural network 124 may be trained to perform graph-level classifications and/or graph similarity prediction-based tasks. For example, such training data may include data representative of a tree structure similar to the tree structure 800 of FIG. 8 where only preapproved components are included within the structure and each preapproved component (or each node) is labeled with a corresponding component classification. In such an example, the graph neural network 124 may be configured to learn embeddings for each preapproved component such that the graph neural network 124 may be applied to new components and assign a detected component classification based on the embeddings. In some examples, when detecting a component classification of a new component, a methodology, such as a voting system among parent-child nodes to assess which node is most suited to be the root of the detected component, may be applied to determine the correct depth in a tree structure when assigning the specific component classification.

In various embodiments, a graph neural network 124 may be trained using either or both of training data including at least text-based representations of a plurality of labeled nodes indicating a component classification for each labeled node or training data including at least text-based representations of a plurality of nodes (e.g., frames and/or layers) that make up preapproved components that are labeled with corresponding component classifications. For example, in some embodiments, the component classification training may comprise training the graph neural network to identify pre-approved components via pre-approved component training data (e.g., training a graph classification model using a library of known pre-approved components) and/or the component classification training may comprise training the graph neural network to classify various identified components with or without regard to their pre-approved status (e.g., training a node classification model using the manually labeled dataset with fictional parent layers). In some embodiments, the graph neural networks may be configured to detect the absence of one or more pre-approved components. For example, in some embodiments, compliance parameters may require certain components to be included in an interface, and the graph neural network or another model (e.g., a rules-based model) may be configured to detect the absence of a required component. Additionally or alternatively, a pre-approved component may include one or more pre-approved components (e.g., pre-approved subcomponents) therein, such that analysis of the pre-approved component may identify missing sub-components thereof.

The models may be configured to output varying degrees of granularity and specificity, such as classifying components by type. In various embodiments, different graph neural networks 124 may be applied based on different particular use cases. In some embodiments, the training data for the graph neural networks 124 may be stored and/or received from one or more of the component prediction repositories 128. Additionally or alternatively, various architectures for various graph neural network 124, their associated weights and/or parameters, and/or the like, may be stored and/or received from the one or more component prediction repositories 128.

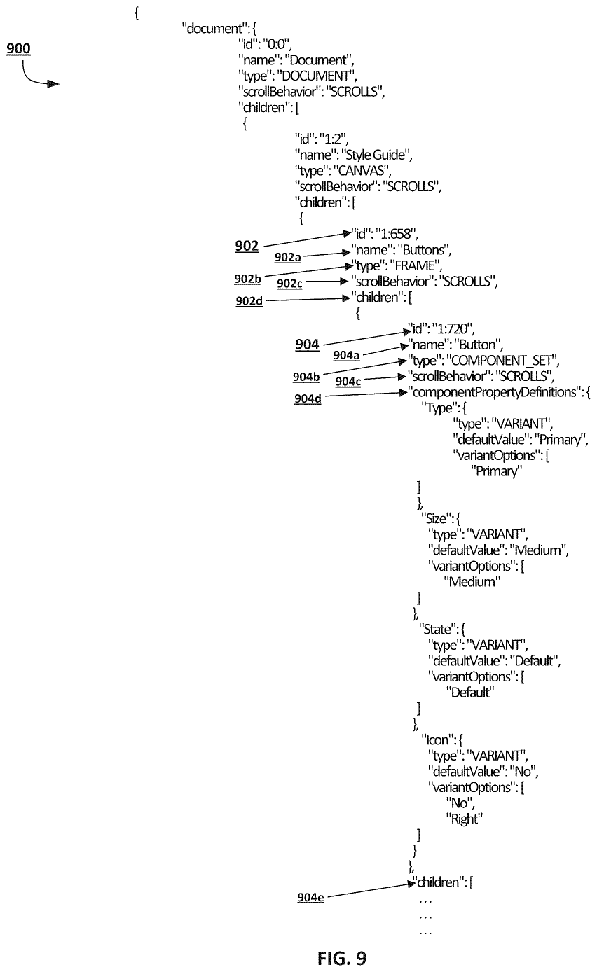

FIG. 9 illustrates an example embodiment of a portion of an interface design data object 900. The depicted interface design data object 900 is a non-limiting example, and it should be appreciated that various other interface data objects may be used in accordance with the embodiments described herein. Additionally, for simplicity, only a portion of the interface design data object 900 is shown. The interface design data object 900 includes a plurality of lines of code (e.g., a . JSON file or the like) defining various frames and/or layers, attributes, and, parent-child relationships associated with a graphical user interface. Each frame and/or layer defined by the interface design data object 900 may be associated with one or more attributes and one or more relationships to other frames and/or layers (e.g., parent-child relationships), and one or more frames and/or layers may make up one or more components. For example, a frame containing one or more buttons (i.e., components) is defined beginning at line 902. As shown at lines 902a-c, the frame includes a plurality of attributes. As shown at line 902d, the frame also includes a plurality of child frames and/or layers (e.g., nested frames and/or layers), one or more of which make up the one or more buttons contained within the frame. One such child frame or layer is defined beginning at line 904. The frame or layer defined beginning at line 904 is a root frame or layer for a button (i.e., component) and, similarly to the frame defined above, includes a plurality of attributes (e.g., 904a-d) and children frames and/or layers (e.g., 904e) defined in the following lines of code of the interface design data object 900.

As described herein, in various embodiments, the interface design data object 900 may represent a graphical user interface associated with the software program system 130 and may be provided to the component prediction system 120 to perform one or more of the various actions described herein. In some embodiments, the data ingestion engine 126 may process the interface design data object 900 (e.g., to identify each frame and/or layer, corresponding attributes, and parent-child relationships) to generate an input data object configured for input to the graph neural network(s) 124. Example embodiments may apply the graph neural network(s) 124 to such an input data object to generate one or more predicted classifications (e.g., a node-level classification that classifies the frame or layer beginning at line 904 as a root frame or layer).

### Example Methods

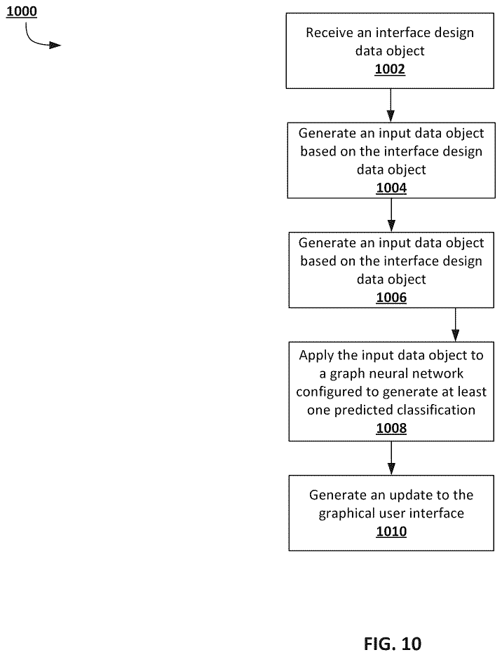

FIG. 10 illustrates an example flowchart depicting an example set of operations for generating updates to a graphical user interface in accordance with at least some example embodiments of the present disclosure. As depicted at block 1002, the process 1000 begins to receive an interface design data object. In some embodiments, the interface design data object includes a text-based representation of a graphical user interface.

At block 1004, the process continues to generate an input data object based on the interface design data object. In some embodiments, the input data object represents a plurality of nodes related to each other based on the interface design data object indicating the at least one parent or child node.

At block 1006, the process continues to apply the input data object to a graph neural network. For example, the graph neural network may be configured to generate at least one predicted classification associated with at least one of the plurality of nodes.

At block 1008, the process continues to apply the audiovisual inputs into a multimodal performance analysis engine to generate one or more performance analysis data objects.

At block 1010, the process continues to generate an update to the graphical user interface. For example, the update to the graphical user interface may be generated based on the at least one predicted classification.

### Example Machine Learning Framework

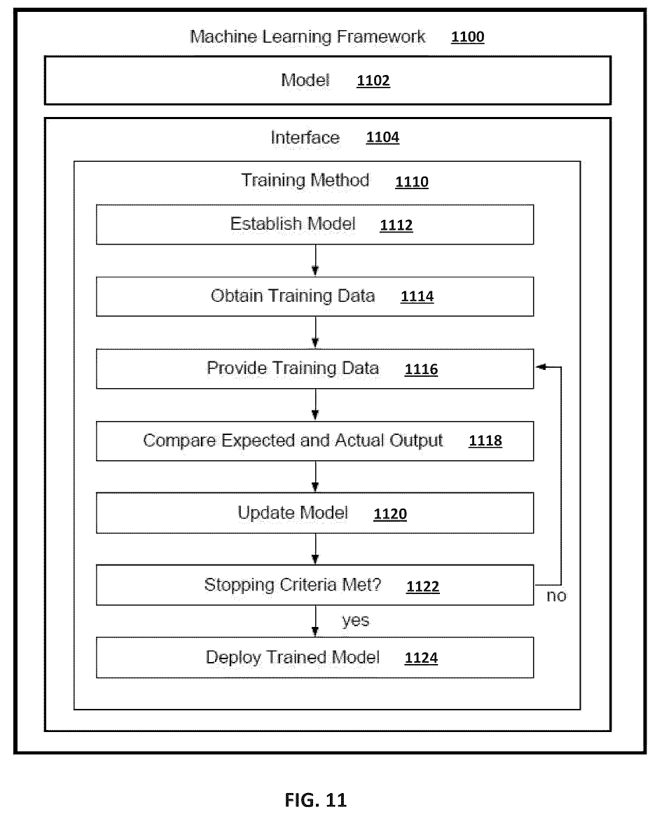

FIG. 11 illustrates an example machine learning framework 1100 that techniques described herein may benefit from or improve on. A machine learning framework 1100 is a collection of software and data that implements artificial intelligence trained to provide output, such as predictive data, based on input. In general, examples of artificial intelligence that can be implemented with machine learning may include neural networks (including recurrent neural networks), language models (including so-called “large language models”), generative models, natural language processing models, adversarial networks, decision trees, Markov models, support vector machines, genetic algorithms, others, or combinations thereof. In the present disclosure, various graph neural networks (also referred to as “GNN”s) may be trained in accordance with the following processes to carry out the functions described herein. Non-limiting examples of GNNs according to the present disclosure include Graph Convolutional Neural Networks (GCN), Graph Attention Networks (GAT), GraphSAGE (Graph Sample and Aggregation), Graph Isomorphism Networks (GIN), and Message Passing Neural Networks (MPNN), among others. For example, some embodiments discussed above may utilize a two-layer GCN structured, trained, and operated as discussed herein. Graph neural networks according to various embodiments of the present disclosure may be customized to recognize a tree structure. For example, the GNN may be trained to identify the root node and structure of root nodes within the graphical user interface, and analyze the aggregated structure of the children below each root node. Each node's data set may include aggregated data comprising the children beneath the respective node.

A person of skill in the art having the benefit of this disclosure will understand that these artificial intelligence implementations need not be equivalent to each other and may instead select from among them based on the context in which they will be used. Machine learning frameworks 1100 or components thereof are often built or refined from existing frameworks, such as TENSORFLOW by GOOGLE, INC. or PYTORCH by the PYTORCH community. The machine learning frameworks 1100 may correspond to techniques as leveraged by the various data processors as described herein for various data processing functions.

The machine learning framework 1100 can include one or more models 1102 that are the structured representation of learning and an interface 1104 that supports use of the model 1102. The model 1102 may include can take any of a variety of forms. In many examples, the model 1102 includes representations of nodes (e.g., neural network nodes, other nodes, or combinations thereof) and connections between nodes (e.g., weighted or unweighted unidirectional or bidirectional connections). In certain implementations, the model 1102 can include a representation of memory (e.g., providing long short-term memory functionality). Where the set includes more than one model 1102, the models 1102 can be linked, cooperate, or compete to provide output.

The interface 1104 can include software procedures (e.g., defined in a library) that facilitate the use of the model 1102, such as by providing a way to establish and interact with the model 1102. For instance, the software procedures can include software for receiving input, preparing input for use (e.g., by performing vector embedding, such as using Word2Vec, BERT, or another technique), processing the input with the model 1102, providing output, training the model 1102, performing inference with the model 1102, fine tuning the model 1102, other procedures, or combinations thereof.

In an example implementation, interface 1104 can be used to facilitate a training method 1110. The training method 1110 may therefore include or be used to implement operation 224 of FIG. 2. The training method 1110 may include operation 1112, which includes establishing a model 1102, such as initializing a model 1102. The establishing can include setting up the model 1102 for further use (e.g., by training or fine tuning). The model 1102 can be initialized with values. In examples, the model 1102 can be pretrained.

Operation 1114 can follow operation 1112. Operation 1114 includes obtaining training data; in many examples, the training data includes pairs of input (e.g., training sequence data objects and respective contextual data objects) and desired output (e.g., labels) given the input. In supervised or semi-supervised training, the data can be prelabeled, such as by human or automated labelers. In unsupervised learning the training data can be unlabeled. In some example embodiments, the training data may be labeled using the fictional node insertion process discussed herein.

Many examples herein are related to supervised prediction of disruptions to pinpoint the weights or importance of events. But certain embodiments may operate without explicit labels but with implicit labels computed based on other data. Thus data need not be explicitly labeled. But it can be beneficial to use an input labeler to infer labels and to train a supervised model.

The training data can include validation data used to validate the trained model 1102. Operation 1116 can follow operation 1114. Operation 1116 includes providing a portion of the training data to the model 1102. This can include providing the training data in a format usable by the model 1102. The machine learning framework 1100 (e.g., via the interface 1104) can cause the model 1102 to produce an output based on the input.

Operation 1118 can follow operation 1116. Operation 1118 includes comparing the expected output with the actual output. In an example, this can include applying a loss function to determine the difference between expected and actual data. This value can be used to determine how training is progressing. Operation 1120 can follow operation 1118. Operation 1120 includes updating the model 1102 based on the result of the comparison. This can take any of a variety of forms depending on the nature of the model 1102. Where the model 1102 includes weights, the weights can be modified to increase the likelihood that the model 1102 will produce correct output given an input. Depending on the model 1102, backpropagation or other techniques can be used to update the model 1102.

Operation 1122 can follow operation 1120. Operation 1122 includes determining whether a stopping criterion has been reached, such as based on the output of the loss function (e.g., actual value or change in value over time). In addition, or instead, whether the stopping criterion has been reached can be determined based on a number of training epochs that have occurred or an amount of training data that has been used. In some examples, satisfaction of the stopping criterion can include if the stopping criterion has not been satisfied, the flow of the method can return to operation 1114. If the stopping criterion has been satisfied, the flow can move to operation 1122.

Operation 1124 includes deploying the trained model 1102 for use in production, such as providing the trained model 1102 with real-world input data and produce output data used in a real-world process. The model 1102 can be stored in memory of at least one computer or distributed across memories of two or more such computers for production of output data.

The use of a computer and network implemented system in generating outputs, and associated electronic communications, enables leveraging of machine learning processes, neural networks, and attention mechanisms to efficiently extract meaningful outputs from large datasets, by embedding respective contextual data in the attention mechanism along with respective sequence data objects. Accordingly, example embodiments provide improvements over systems that merely process input sequences, or sequence data objects, without context. The improvements may be realized with input data that spans long timeframes of multiple sequence events. The generated outputs are also more accurate and are able to detect latent and hidden relationships between multiple sequenced events.

Example embodiments may simultaneously consider multiple types of contextual data objects (e.g., subsequence contexts, token-level contexts, and token-to-token contexts). Example embodiments, learn, understand, and predict latent pattern of data not only considering the sequence data object, such as transactional data, but further contextualize each sequence within its context-including any known subsequence contexts, token-level contexts, and token-to-token contexts. Example embodiments further leverage the attention mechanism to provide an importance scoring or weighting of the features within an input sequence as well as in the contextual data.

Additionally, example embodiments may create one model across all subjects and entities, to make generalization across users, demographics, or other groupings of people or entire populations. Example embodiments may therefore generate a foundational model that directly enables various downstream application and tasks.

By sharing model parameters and applying transfer learning techniques across customers, example embodiments can leverage the knowledge gained from one customer's transactional data to improve the forecasting for another. This transfer of learning allows the model to generalize across customers and capture common patterns and trends, resulting in more accurate predictions.

### Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A component prediction system comprising at least one processor and at least one non-transitory memory, the at least one non-transitory memory comprising computer coded instructions therein, wherein the computer coded instructions are configured to, when executed by the at least one processor, cause the component prediction system to:
receive an interface design data object, the interface design data object comprising a text-based hierarchical code structure defining a plurality of frames associated with one or more components of a graphical user interface;
generate an input data object using the interface design data object, the input data object configured to be input to a graph neural network, the input data object comprising at least one matrix comprising one or more vectorized representations of a plurality of nodes corresponding to the plurality of frames and related to each other based on the interface design data object indicating at least one parent or child relationship among the plurality of nodes;
apply the at least one matrix of the input data object to the graph neural network configured to generate at least one predicted classification associated with at least one of the plurality of nodes identifying at least one of the one or more components as noncompliant with one or more preapproved components, the graph neural network trained using a training data set comprising the one or more preapproved components; and
based on the at least one predicted classification, generate an update to the graphical user interface, the update comprising a replacement component configured to replace the at least one of the one or more components in response to the at least one predicted classification.

2. The component prediction system of claim 1, wherein the input data object comprises (i) a node feature matrix comprising one or more vectorized representations of the plurality of nodes comprising features associated with the plurality of nodes, and (ii) an adjacency matrix comprising one or more vectorized representations of the plurality of nodes related to each other.

3. The component prediction system of claim 1, wherein a component of the graphical user interface comprises one or more of the plurality of nodes, the one or more of the plurality of nodes comprising at least one root node defining a start of the component.

4. The component prediction system of claim 1, wherein the computer coded instructions are configured to, when executed by the at least one processor, further cause the component prediction system to:
query an application programming interface (API) using a file key or uniform resource locator (URL) associated with the interface design data object to receive the interface design data object.

5. The component prediction system of claim 1, wherein the computer coded instructions are configured to, when executed by the at least one processor, further cause the component prediction system to:
train the graph neural network using training data comprising a text-based representation of each of a plurality of labeled training nodes, wherein a respective labeled training node of the plurality of labeled training nodes comprises at least a label indicating a component classification of the respective labeled training node.

6. The component prediction system of claim 1, wherein the computer coded instructions are configured to, when executed by the at least one processor, further cause the component prediction system to:
train the graph neural network using training data comprising a text-based representation of each of a plurality of training nodes, wherein the plurality of training nodes define a preapproved component associated with a component classification.

7. The component prediction system of claim 1, wherein generating the at least one predicted classification comprises generating, via the graph neural network, at least one node-level classification for at least one of the plurality of nodes indicating at least one of (i) a component classification, or (ii) a root classification, and wherein the at least one predicted classification comprises the at least one node-level classification.

8. The component prediction system of claim 1, wherein generating the at least one predicted classification comprises generating, via the graph neural network, at least one graph-level classification for at least two of the plurality of nodes indicating a component classification, and wherein the at least one predicted classification comprises the at least one graph-level classification.

9. The component prediction system of claim 8, wherein the computer coded instructions are configured to, when executed by the at least one processor, further cause the component prediction system to:
apply a root node voting system to determine a root classification for at least one node of a graph respective to the at least one graph-level classification.

10. The component prediction system of claim 1, wherein generating an update to the graphical user interface comprises at least one of (i) providing an indication of at least one component within the graphical user interface to be reviewed, (ii) providing an indication of at least one component within the graphical user interface to be replaced with at least one preapproved component, or (iii) replacing at least one component within the graphical user interface with at least one preapproved component.

11. A computer-implemented method comprising:
receiving, by one or more processors, an interface design data object, the interface design data object comprising a text-based hierarchical code structure defining a plurality of frames associated with one or more components of a graphical user interface;
generating, by one or more processors, an input data object using the interface design data object, the input data object configured to be input to a graph neural network, the input data object comprising at least one matrix comprising one or more vectorized representations of a plurality of nodes corresponding to the plurality of frames and related to each other based on the interface design data object indicating at least one parent or child relationship among the plurality of nodes;
applying, by one or more processors, the at least one matrix of the input data object to the graph neural network configured to generate at least one predicted classification associated with at least one of the plurality of nodes identifying at least one of the one or more components as noncompliant with one or more preapproved components, the graph neural network trained using a training data set comprising the one or more preapproved components; and
based on the at least one predicted classification, generating, by one or more processors, an update to the graphical user interface, the update comprising a replacement component configured to replace the at least one of the one or more components in response to the at least one predicted classification.

12. The computer-implemented method of claim 11, wherein the input data object comprises (i) a node feature matrix comprising one or more vectorized representations of the plurality of nodes comprising features associated with the plurality of nodes, and (ii) an adjacency matrix comprising one or more vectorized representations of the plurality of nodes related to each other.

13. The computer-implemented method of claim 11, wherein a component of the graphical user interface comprises one or more of the plurality of nodes, the one or more of the plurality of nodes comprising at least one root node defining a start of the component.

14. The computer-implemented method of claim 11, further comprising:
training the graph neural network using training data comprising a text-based representation of each of a plurality of labeled training nodes, wherein a respective labeled training node of the plurality of labeled training nodes comprises at least a label indicating a component classification of the respective labeled training node.

15. The computer-implemented method of claim 11, further comprising:
training the graph neural network using training data comprising a text-based representation of each of a plurality of training nodes, wherein the plurality of training nodes comprise a preapproved component associated with a component classification.

16. The computer-implemented method of claim 11, wherein generating the at least one predicted classification comprises generating, via the graph neural network, at least one node-level classification for at least one of the plurality of nodes indicating at least one of (i) a component classification, or (ii) a root classification, and wherein the at least one predicted classification comprises the at least one node-level classification.

17. The computer-implemented method of claim 11, wherein generating the at least one predicted classification comprises generating, via the graph neural network, at least one graph-level classification for at least two of the plurality of nodes indicating a component classification, and wherein the at least one predicted classification comprises the at least one graph-level classification.

18. The computer-implemented method of claim 17, further comprising:
applying a root node voting system to determine a root classification for at least one node of a graph respective to the at least one graph-level classification.

19. The computer-implemented method of claim 11, wherein generating an update to the graphical user interface comprises at least one of (i) providing an indication of at least one component within the graphical user interface to be reviewed, (ii) providing an indication of at least one component within the graphical user interface to be replaced with at least one preapproved component, or (iii) replacing at least one component within the graphical user interface with at least one preapproved component.

20. At least one non-transitory computer readable medium comprising computer coded instructions therein, wherein the computer coded instructions are configured to, when executed by at least one processor:
receive an interface design data object, the interface design data object comprising a text-based hierarchical code structure defining a plurality of frames associated with one or more components of a graphical user interface;
generate an input data object using the interface design data object, the input data object configured to be input to a graph neural network, the input data object comprising at least one matrix comprising one or more vectorized representations of a plurality of nodes corresponding to the plurality of frames and related to each other based on the interface design data object indicating at least one parent or child relationship among the plurality of nodes;
apply the at least one matrix of the input data object to the graph neural network configured to generate at least one predicted classification associated with at least one of the plurality of nodes identifying at least one of the one or more components as noncompliant with one or more preapproved components, the graph neural network trained using a training data set comprising the one or more preapproved components; and
based on the at least one predicted classification, generate an update to the graphical user interface, the update comprising a replacement component configured to replace the at least one of the one or more components in response to the at least one predicted classification.
